(19) United States
(12) Patent Application Publication
(10) Pub. No.: US 2014/0006312 A1
(43) Pub. Date: Jan. 2, 2014

(54) SYSTEM AND METHOD FOR AGGREGATING BANK AND CORPORATE CALENDARS

(71) Applicants: William Tudor Fennebresque, New York, NY (US); Robert Edgar Long, III, New York, NY (US)

(72) Inventors: William Tudor Fennebresque, New York, NY (US); Robert Edgar Long, III, New York, NY (US)

(21) Appl. No.: 13/928,854

(22) Filed: Jun. 27, 2013

Related U.S. Application Data
(60) Provisional application No. 61/665,052, filed on Jun. 27, 2012.
(60) Provisional application No. 61/699,407, filed on Sep. 11, 2012.

(51) Int. Cl. G06Q 40/06

(52) U.S. Cl. CPC G06Q 40/06
USPC 705/36 R

(57) ABSTRACT

A system and methods are provided for investors to review, reconcile and rate requested events and any research provided over a time period by brokerage houses. A dashboard may be provided that permits tracking of current activity for assistance in determining that commission allocations are in line with the amount of research being provided. At the end of a time period, a broker vote may be facilitated for collecting investor votes and producing reports and scorecards which may be shared with brokers, or may create a research valuation scheme to quantitatively determine which brokers are providing more value.

### CROSS-REFERENCE TO RELATED APPLICATIONS

This application claims benefit and priority to U.S. Provisional Application No. 61/665,052 filed Jun. 27, 2012, and also claims benefit and priority to U.S. Provisional Application No. 61/699,407 filed Sep. 11, 2012, the disclosures of which are incorporated by reference herein in their entirety.

### BACKGROUND OF THE DISCLOSURE

1.0. Field of the Invention

The invention is related generally to a system and method for aggregating bank and corporate calendars and, more particularly, to a system and method for aggregating corporate access event information from sell-side institutions, such as, e.g., banks, for use by buy-side investors such as institutional investors, and the like.

2.0. Related Art

In one aspect, the business relationship between Funds and Brokers (e.g., Banks), may be described in a simple manner, namely, funds buy and sell stocks through Brokers, and the Brokers get paid for these transactions. But in reality the relationship is more nuanced. Brokers also provide corporate access and research which help fund investors evaluate companies (e.g., stocks, bonds, investment opportunities, and the like) which they might currently own or are thinking of investing in.

When a fund buys or sells stocks, they may buy and sell these through any number of brokers. But in order to compensate the brokers for the value-added research services they have provided, Funds often try to spread the trades around so that a given broker may receive commission fees commensurate with the value of research they have provided.

How a fund tracks the value of research provided varies widely. Typically, investors “sat around a table” and voted (“broker vote”), and this influenced or even determined how much commission was paid to each broker. Paying commissions and voting usually occurs quarterly or semiannually.

Recently, there is greater pressure from government, fund management and investors to make this process more qualitative and fair. Funds must rationalize how much they pay brokers and also qualitatively convey whether the broker is providing good research value for that pay. Investors, as a result, are being asked to track their interactions with the brokers' research team. Moreover, investment fund personnel increasingly must keep detailed records about their activities with brokers and quantify the value services provided by each broker, which may result in a broker vote to determine which brokers are providing better services. There are very few tools in the industry which help with a broker vote, but nothing widely used and nothing very effective. As an investor, keeping detailed records for such voting can be time consuming and inaccurate, while also impacting day-to-day activities. Fund managers do not want to chase after their portfolio managers and analysts and bother them about their activity logs.

Investors are mostly just logging activity in a spreadsheet, perhaps with help from their administration team. Typically, much of the logging happens towards the end of the quarter when they may need to submit their activity to their management, which may involve looking through old emails to ascertain history of activity.

These activity logs from each investor may be aggregated at a fund-wide level and rarely quantified. Not all research or events are equally valuable, so there can be points or even dollar values assigned to these research items, which may or may not Occur.

The brokers may also help the funds by reconciling the activity log with their own records. Motivated brokers may be better at keeping track of things, while others are not.

Information regarding the availability of corporate access events for one or more corporations or organizations by sell-side institutions, such as, for example, banks, have been disseminated by the sell-side institutions through sales teams by email and/or phone calls to buy-side investors, such as, for example, hedge funds, private equity funds, mutual funds, retirement funds and the like.

Buy-side investors are typically forced to rely on sales teams at the various sell-side institutions, or other hosting party, to keep abreast of upcoming corporate access events which may lead to excessive and inefficient emails from the sell-side regarding corporate access events for specific or a multiplicity of companies or organizations. Moreover, there is no certainty for the buy-side investors that they will be receiving advanced notices from sell-side institutions of upcoming access events.

Corporate access events may include, for example, informational meetings by corporate executives, information luncheons, conferences that might highlight certain corporate or industry executives, one-on-one meeting/interviews, group events, field trips by or to certain companies, video and/or phone calls with specific executives or company executives, and the like. In this way, buy-side investors or their representatives (e.g., analysts) may gather company or industry investment-related information in order to assess or develop a better understanding of investment opportunities or deeper awareness of investment markets generally, or one or more specific companies in particular.

As such, a solution for providing better and more convenient communications capabilities for buy-side clients and sell-side institutions alike.

### SUMMARY OF THE INVENTION

The invention as described herein solves many of the problems described above and provides for a more efficient process for tracking and quantifying requested events and research provided over a time period by brokers, among other features. In one aspect, a computerized platform may be configured to make it easy to see and request broker-provided corporate access and research events, and configured to provide tracking of such activity. In one aspect, the system and methods provide for investors to review, reconcile and rate requested events and research provided over a time period. The system and method of the invention may also provide fund managers with a dashboard which permits tracking of current activity for assistance in determining that commission allocations are in line with the amount of research being provided. At the end of a time period, a broker vote may be facilitated for collecting investor votes and producing reports and scorecards which may be shared with brokers, or may create a research valuation scheme to quantitatively determine which brokers are providing more value.

The invention, as described herein, discloses a system and method for providing aggregated corporate access event information from sell-side institutions, such as banks, for use by buy-side investors such as institutional investors, and the like, may be implemented as a cloud based interface, such as, for example, as provided by a web server to a multiplicity of network based clients. In one aspect, buy-side clients may respond to offers for corporate access events that are sent based on a profile maintained for the buy-side clients. The profiles may indicate the types of corporate events for which the buy-side clients wish to receive information and scheduling notices. Responses to accept such offers may be automatically processed so that calendars for both the buy-side clients and sell-side institutions are automatically maintained.

In one aspect, a system for providing targeted communications between a first financial party and at least one second financial party is provided that includes a component executing on a computer platform to track at least one offering from a plurality of sell-side financial parties, a component executing on the computer platform to calculate a quantity of the at least one offerings that was requested by a requesting buy-side investor and granted by at least one of the plurality of sell-side financial parties or a hosting party and a component executing on the computer platform to record and report how many of the calculated quantity were attended by the buy-side investor. The system may further include a component executing on the computer platform to receive at least one broker vote and a component executing on the computer platform to calculate a broker ranking based at least in part on the broker vote.

In one aspect, a computer-implemented method for providing targeted communications between a first financial party and at least one second financial party, the method comprising the steps of creating an interest list for at least one investor associated with the first financial party, sending at least one request for information over a network to a plurality of second financial parties maintained in the interest list, calendaring at least one event based on received information from the plurality of second financial parties, recording whether or not the at least one event was attended, allocating points to at least one of the plurality of second financial parties based on a result of the at least one event and calculating and displaying a commission allocation based on at least in part the allocated points, wherein the steps of creating, sending, calendaring, recording, allocating, and calculating are performed by a computer.

In one aspect, a computer-implemented method for providing targeted communications between a first financial party and at least one second financial party, the method comprising the steps of: assigning points by a first financial party or by individual investors associated with the first financial party to a plurality of sell-side financial parties, accumulating points for each the plurality of sell-side financial parties; and calculating and reporting a commission allocation for each the plurality of sell-side financial parties based on, at least in part, the accumulated points, wherein each of the steps are performed by a computer.

In one aspect, a computer-implemented method for providing targeted communications between a first financial party and at least one second financial party, the method comprising the steps of: searching for at least one scheduled event by at least one of: meeting type, geography and a predetermined interest list, sending at least one request for information over a network to at least one of a plurality of second financial parties and calendaring at least one scheduled event based on received information from the at least one of the plurality of second financial parties, wherein the steps of searching, sending and calendaring are performed by a computer. The computer-implemented method may further include the steps of: recording whether or not the at least one scheduled event was attended, allocating points to at least one of the plurality of second financial parties based on a result of the at least one scheduled event and calculating and displaying a commission allocation based on, at least in part, the allocated points.

In one aspect, a computer program product embodied on a physical computer storage medium is provided. The computer program product may include computer software code that when read from the storage medium and executed, performs the following steps: searching for at least one scheduled event received as input from a first financial party, the input including at least one of: meeting type, geography of the scheduled event and a predetermined interest list, sending at least one request for information for the at least one scheduled event over a network to at least one of a plurality of second financial parties and calendaring at least one scheduled event based on received information from the at least one of the plurality of second financial parties. The computer program product may further include computer software code that performs the steps of processing a broker vote from a user associated with the first financial party and calculating an amount of points to be allocated to the plurality of second financial parties based on the broker vote.

In one aspect, a computer-implemented method for providing targeted communications between a first buy-side entity and at least one second party is provided. The computer-implemented method may be performed by a computer system having a server and a database, the method comprising the steps of searching for internal sponsored events stored in the database based on parameters, wherein the internal sponsored events include at least one of: a conference and a meeting, cross-referencing the internal sponsored events with an interest list and displaying the results of the searching and cross-referencing. The cross-referencing step may include cross-referencing based on at least one of: a specific industry, a specific company, a geographic region, a public company and a private company. The computer-implemented method may further include the steps of sending by the server at least one request for information over a network to at least one of second parties and calendaring at least one scheduled event based on received information from the at least one of the second parties The computer-implemented method may further include the steps of receiving a response from the at least one of second parties and displaying a summary of received responses received over a predetermined time period.

Additional features, advantages, and embodiments of the invention may be set forth or apparent from consideration of the following attached detailed description and drawings. Moreover, it is to be understood that both the foregoing summary of the invention and the following attached detailed description are exemplary and intended to provide further explanation without limiting the scope of the invention as claimed.

### BRIEF DESCRIPTION OF THE DRAWINGS

The accompanying drawings, which are included to provide further understanding of the disclosure, are incorporated in and constitute a part of the specification, illustrate examples of the disclosure and together with the detailed description serve to explain the principles of the invention. No attempt is made to show structural details of the disclosure in more detail than may be necessary for a fundamental understanding of the disclosure and the various ways in which it may be practiced. In the drawings:

FIG. 1 is a simplified block diagram of an exemplary system configuration including a computerized network that may support various operational features, according to principles of the disclosure;

FIG. 2 is an exemplary Graphical User Interface (GUI) for a buy-side client which permits setting parameters indicating industries or companies of interest, according to principles of the invention;

FIG. 3 illustrates a GUI that a buy-side client may view and optionally select from, according to principles of the invention;

FIG. 4 is an exemplary calendar for a particular buy-side client, which is shown as a displayed GUI, according to principles of the invention;

FIG. 5 illustrates an exemplary email that may be generated when a buy-side client selects a particular event to “attend” or participate in, according to principles of the invention;

FIG. 6 is an exemplary display showing meetings scheduled for a particular week, for a particular buy-side client, according to principles of the invention;

FIG. 7 is an exemplary graphical user interface showing an individual investor's activity log, according to principles of the invention;

FIG. 8 is an exemplary GUI that permits a user to log requests into the system if the system did not handle the requests, according to principles of the invention;

FIG. 9 is an exemplary GUI showing an individual investor's input/tracking page, according to principles of the invention;

FIG. 10 is an exemplary GUI showing Broker Vote settings for various sell-side offerings, according to principles of the invention;

FIG. 11 is an exemplary GUI showing point allocation for various sell-side offerings, according to principles of the invention;

FIG. 12 is an exemplary GUI showing a summary of broker ranking levels, according to principles of the invention;

FIG. 13 is an exemplary GUI showing investor level rankings, according to principles of the invention;

FIG. 14 is an exemplary GUI showing underlying activity that contributed to the information displayed in FIG. 13, according to principles of the invention;

FIG. 15 is an exemplary GUI showing a fund level view based on the GUI of FIG. 13, except based on multiple investors, according to principles of the invention;

FIG. 16 is an exemplary GUI similar to the GUI of FIG. 15 except it is presented in dollar amounts, according to principles of the invention;

FIG. 17 is an exemplary GUI showing a scorecard for an exemplary broker, according to principles of the invention;

FIG. 18 is a flow diagram showing an example process, the steps performed according to principles of the invention;

FIG. 19 is an exemplary GUI showing a listing of conferences by geographic location, according to principles of the invention;

FIG. 20 is an exemplary GUI showing detailed information of a selected conference, according to principles of the invention;

FIG. 21 is an exemplary GUI showing a listing of non-deal roadshows (NDR) for a selected geographic area, according to principles of the invention;

FIG. 22 is an exemplary GUI showing a listing of non-deal roadshows (NDR) for a selected geographic area, according to principles of the invention;

FIG. 23 is an exemplary GUI showing exemplary settings for receiving emails, according to principles of the invention;

FIG. 24 is an exemplary GUI showing an internal meetings list, according to principles of the invention;

FIG. 25 is an exemplary GUI showing adding a new Internal Meeting, according to principles of the invention; and

FIG. 26 is a GUI showing a listing of weekly (or other time period) emails that a user may receive related to the Internal meetings lists, according to principles of the invention.

### DETAILED DESCRIPTION OF THE DISCLOSURE

The examples of the disclosure and the various features and advantageous details thereof are explained more fully with reference to the non-limiting examples that are described and/or illustrated in the accompanying drawings and detailed in the following attached description. It should be noted that the features illustrated in the drawings are not necessarily drawn to scale, and features of one example may be employed with other examples as the skilled artisan would recognize, even if not explicitly stated herein. Descriptions of well-known components and processing techniques may be omitted so as to not unnecessarily obscure the overall features of the disclosure. The examples used herein are intended merely to facilitate an understanding of ways in which the invention may be practiced and to further enable those of skill in the art to practice the examples of the disclosure. Moreover, it is noted that like reference numerals represent similar parts throughout the several views of the drawings.

A “computer”, as used in this disclosure, means any machine, device, circuit, component, or module, or any system of machines, devices, circuits, components, modules, or the like, which is (are) capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like. Further, the computer may include an electronic device configured to communicate over a communication link. The electronic device may include, for example, but is not limited to, a mobile telephone, a personal data assistant (PDA), a mobile computer, a stationary computer, a smart phone, mobile station, user equipment, or the like.

A “server”, as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database”, as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “network,” as used in this disclosure, means an arrangement of two or more communication links. A network may include, for example, the Internet, a local area network (LAN), a wide area network (WAN), a metropolitan area network (MAN), a personal area network (PAN), a campus area network, a corporate area network, a global area network (GAN), a broadband area network (BAN), any combination of the foregoing, or the like. The network may be configured to communicate data via a wireless and/or a wired communication medium. The network may include any one or more of the following topologies, including, for example, a point-to-point topology, a bus topology, a linear bus topology, a distributed bus topology, a star topology, an extended star topology, a distributed star topology, a ring topology, a mesh topology, a tree topology, or the like.

A “communication link” (or “communication links”), as used in this disclosure, means a wired and/or wireless medium that conveys data or information between at least two points. The wired or wireless medium may include, for example, a metallic conductor link, an air link, a fluid medium link, a radio frequency (RF) communication link, an Infrared (IR) communication link, an optical communication link, or the like, or any combination of the foregoing without limitation. The RF communication link may include, for example, WiFi, WiMAX, IEEE 802.11, DECT, 0G, 1G, 2G, 3G or 4G cellular standards, Bluetooth, or the like.

A “computer-readable medium”, as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

The system and method for aggregating corporate access event information from sell-side institutions such as banks for use by buy-side investors such as institutional investors, and the like, may be implemented as a cloud based interface such as for example, as provided by a web server to a multiplicity of network based clients. The system and method of the disclosure makes it easier to see and request broker-provided corporate access and research events. For example, if a user, such as an investor, requests events and/or research information through the system provided herein, the system is configured to keep track of the requests and track associated activity for all registered users such as investors. The system and method of the disclosure makes it easy for investors to go back in time and reconcile and rate the results of requested events and research. Fund managers may also have a dashboard where they can track current activity and make sure their commission allocations are in-line with the amount of research being provided. At the end of the quarter (or other time period), the system facilitates collecting investor votes and producing reports and scorecards which may be, for example, shared with a broker. The system and method herein may permit tailoring research valuation schemes to quantitatively measure which brokers are providing more value. The system and methods herein may be used between a first financial party and a second financial party.

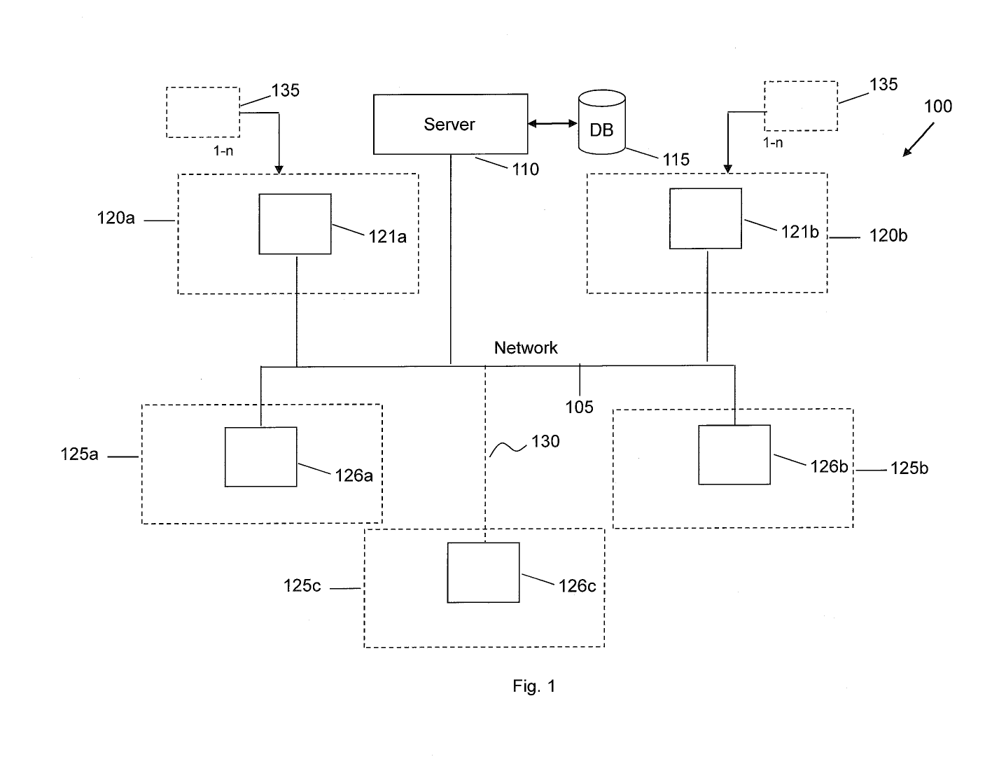

FIG. 1 is a simplified block diagram of an exemplary system configuration, including a computerized network that may support various operational features, according to principles of the disclosure. The system 100 may include a network 105, such as, for example, the Internet, a server 110 coupled to the network 105, a database 115 for storing data utilized by the methods and system of the disclosure and accessible by the server 110. The system 100 may further include one or more sell-side institutions 120a, 120b which may be any institution offering corporate access events such as, but not limited to, banks, brokerage houses and the like. The one or more sell-side institutions 120a, 120b may be providing financial services, such as, for example, research or trading services, related to corporations 135 (or other similar organizations). The sell-side institutions 120a, 120b may access the server 110 via respective computerized devices 121a, 121b over the network 105. The system 100 may further include buy-side clients 125a, 125b, 125c such as institutional investors (e.g., hedge funds, retirement funds, mutual funds, and the like) that may access the server 110 over network 105 utilizing computerized devices 126a, 126b, 126c. Computerized devices 121a, 121b, 126a, 126b, 126c may comprise any computer enabled device that a user might be able to access the server 110, such as, e.g., laptop computers, cell-phones, IPad®, business computers, and the like. Moreover, the computerized devices 121a, 121b, 126a, 126b, 126c may be a wireless device, such as shown in relation to the wireless connection 130 of wireless client device 126c. The server 110 may be any appropriate computer platform with appropriate hardware including memory which may be configured to operationally process the software logic to track the users, points, commissions, communications such as emails, and calculate the broker votes, commissions and percentages described herein. Other processing hardware may be employed as those skilled in the art would recognize.

Typically, one or more corporations 135 may book/schedule non-deal related activities in conjunction with or through sell-side institutions 120a, 120b, who may be, for example, the corporate banker for a respective corporation or organization. These activities may include informational meetings by corporate executives, information luncheons, conferences that might highlight certain corporate or industry executives, one-on-one meeting/interviews, group events, field trips by or to certain companies, video and/or phone calls with specific executives or company executives, and the like.

In the past, prior to this disclosure, the one or more sell-side institutions 120a, 120b may publicize these non-deal related activities via “informal” means such as phone calls or emails, for example, often by sales teams of the sell-side institutions 102a, 120b to the buy-side clients 125a, 125b. However, this “informal” process often leads to inadequate communications to buy-side clients 125a, 125b with much manual tracking, leading to various inefficiencies and lost opportunities. For example, a hedge fund analyst (associated with an institutional investor) might receive an email from Bank A (a sell-side entity) that says that the Bank A is having or sponsoring event x for company B and event z for company C. However, before this disclosure, there is no formal tracking of this communication so that there is accurate/automatic accounting of the acceptance (or declining) by the institutional inventor. Also, the informal process may often lead to overwhelming emails of events in which the buy-side clients 125a, 125b may have no or little interest. Moreover, in the ‘informal” process prior to this disclosure, there is no efficient way to sort through the often very large amounts of responses received from the buy-side clients 125a, 125b by the sell-side institutions 120a, 120b.

The system 100 permits a better directed communications process in that the event offerings are tracked and recorded as the offers are communicated from sell-side institutions 120a, 120b to the buy-side clients 125a, 125b so that the offers to attend events may include descriptions of the events such as type of event, location of event, deadlines for reply, and the like, with automatic calendaring of the acceptances by the buy-side clients 125a, 125b for each event.

A database 115 may maintain buy-side client 125a, 125b information so that preferences of each buy-side client 125a, 125b may be recorded, such as for example, one or more of: type of industries, specific companies, types of events, specific stock exchanges. In this way, a buy-side client 125a, 125b may register with server 110 to create a separate account related to each buy-side client 125a, 125b so that this type of profile information may be established and maintained at database 115.

Each sell-side institution 120a, 120b may then also set up an account with server 110 to establish a communications platform with those buy-side clients 125a, 125b that wish to receive corporate access events notices based on their profile information. The sell-side institutions 120a, 120b may enter new events in the database along with specific parameters to indicate one or more of: types of events, dates, locations, corporate personnel involved, any restrictions, date for replying, and the like. In this way, a specific buy-side client 125a, 125b can create a profile that may establish which sell-side institutions 120a, 120b they may be interested in receiving event notices from. In addition, or alternatively, the buy-side client 125a, 125b may also establish parameters as to which companies, industries and/or sectors for which they may wish to receive event notices. In this way, the buy-side investors may set-up more focused communication with one or more sell-side institutions 120a, 120b via the server 110 and database 115 so that only desired event notices may be sent, thereby avoiding (or minimizing) being overwhelmed with communications for events that the buy-side client 125a, 125b may have no interest.

The server 110 may maintain a general event calendar and coordinate notices about events to buy-side clients 125a, 125b according to the preferences of their established profiles. The server 110 may communicate (bi-directionally) with buy-side clients 125a, 125b by email for example. As buy-side clients 125a, 125b accept event offerings, a calendar may be updated with the acceptance. In this way, both the buy-side clients 125a, 125b and the sell-side institutions 120a, 120b have automatic accounting of events and the tentative numbers of attendees for each specific event for each company 135 (or organization) involved.

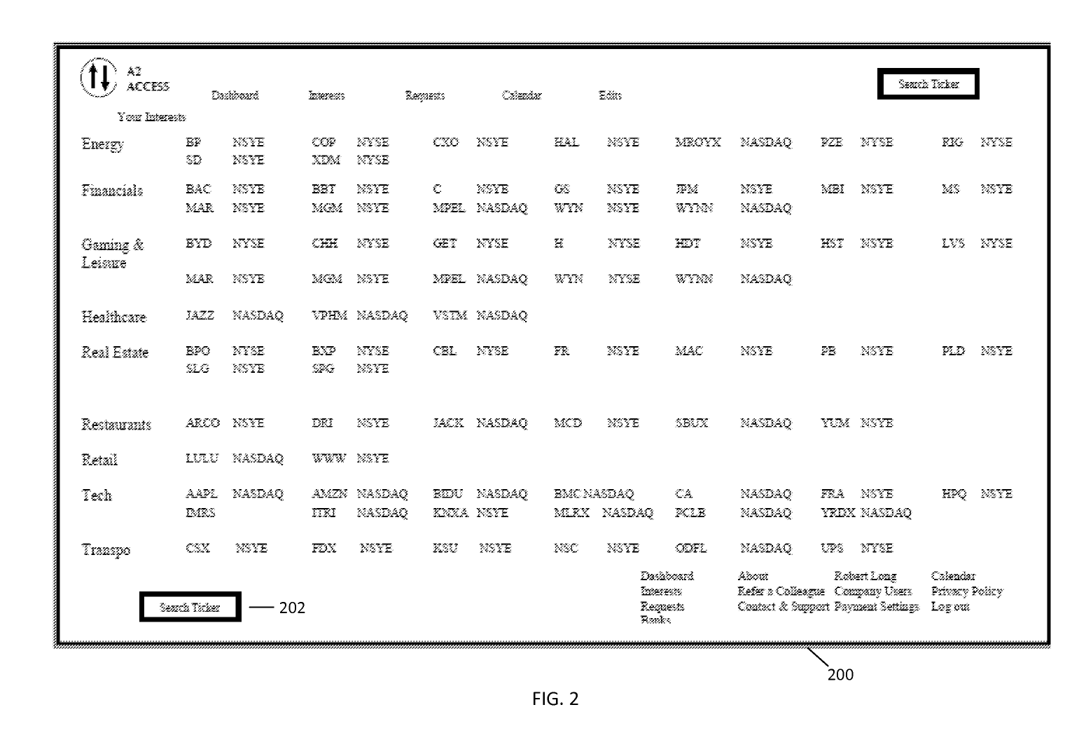

FIG. 2 is an exemplary Graphical User Interface (GUI) 200 for a buy-side client 125a, 125b which permits setting parameters indicating industries or companies of interest, according to principles of the invention. The display of FIG. 2 shows companies by industry, such as, e.g., Energy, Financials, Gaming & Leisure, Healthcare, Real Estate, Restaurants, Retail, Technology (as denoted by “Tech”), Transportation (as denoted by “Transpo”) with ticker symbols of companies that this particular buy-side client might be interested in receiving corporate access event information. This GUI 200 permits access to detailed information for any ticker using the SEARCH TICKER tab. The GUI may be configured to display current selections (i.e., companies) for a buy-side client for each industry and may display the associated stock exchange (e.g., NYSE, NASDAQ, and the like). These selections may be updated by a buy-side client. A search of a ticker (which might be, e.g., highlighted first) may be performed using a search ticker button 202.

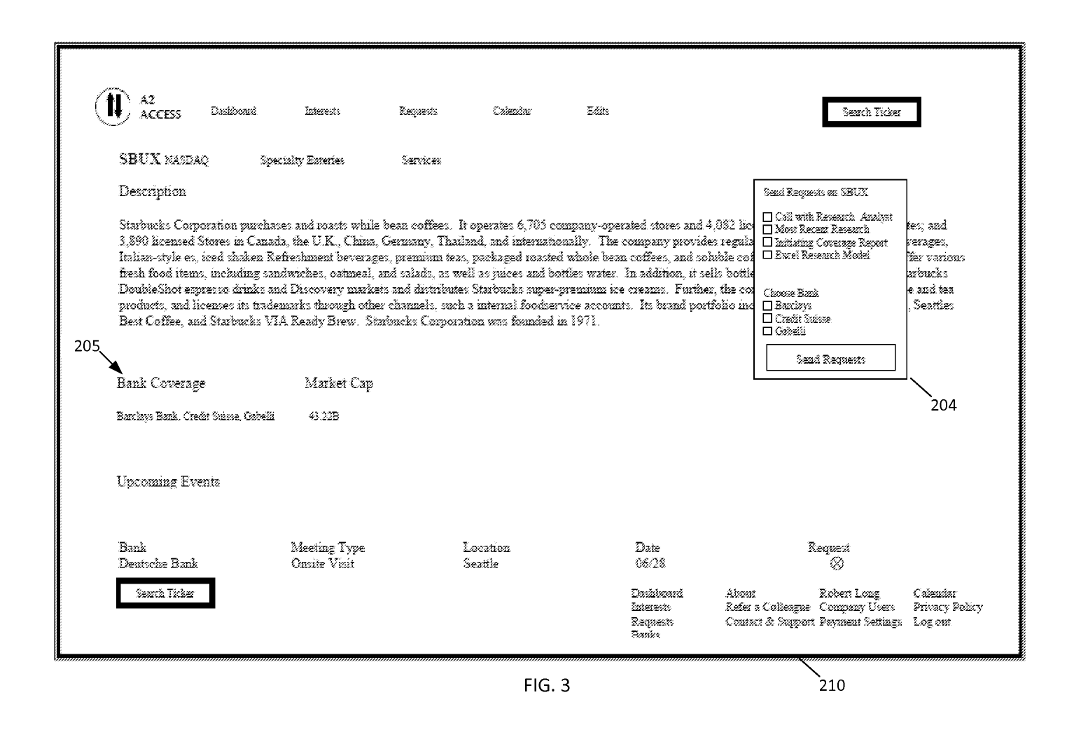

FIG. 3 illustrates a GUI 210 that a buy-side client 125a 125b may view and optionally select from, according to principles of the invention. Generally, this GUI 210 display is configured to provide a Research Request Function and receive user input. This function may permit a user to access a particular stock page where basic information may be pulled from a public source (e.g., Google® Finance or Yahoo®). The system 100 may upload Coverage lists for each bank that allows for the system 100 to show users which banks 205 cover the particular stock the user may be interested in viewing. Configured on the GUI 210 display of FIG. 3 may be a button that may be labeled “Send Request” (or the like) configured to cause a display dropdown list 204 of information entitled “Send Requests on SBUX” that the user might elect to request, along with a feature that indicates which various banks may be covering that particular stock (in this example, SBUX). So, a user may elect to send a request to one or more banks to request information about the target company, in this example SBUX.

Once the user has selected which type of research (e.g., Call with Research Analyst, Most Recent Research, Initiating Coverage Report, Excel Research Model) from the drop down list 204 (and any other additional information) and any of the sell-side firms (e.g., Barclays, Credit Suisse and/or Gabelli from the drop down list 204) from which they would like that information, the system 100 may generate an email that BCCs (“blind carbon copies”) a representative from each sell-side firm (e.g., Barclays, Credit Suisse and/or Gabelli from the drop down list 204) that has been selected. The email may provide the selected sell-side firm(s) with the request for information, and the user's information making the request.

Once the user/investor has sent the request, the request may be tracked on a “Research Request” tracking page that allows users to track how the sell-side firms have responded to their request; examples of tracking responses are: Research Model received, research report received, No response, Call with Analyst granted, Call with Analyst not granted.

The tracking of sell-side research that might be received and corporate access events that may be granted may be used during “broker vote” to identify the sell-side firm that has provided the most value to investors. The system 100 may generate or suggest a rank that may be used by the investors to allocate trade commission to each sell-side firms.

Currently there are no other systems available that are configured to aggregate sell-side coverage and allows investors to request research materials from multiple sell-side firms at one time (with one request action) such as system 100 can provide. These features may create a more efficient and better way for investors to disseminate and then track research requests to sell-side firms.

In particular, FIG. 3 shows detailed information related to company SBUX; including which banks are covering this company. The drop down list 204 (or window) may permit a user to select which type of information for SBUX they may be interested in receiving. A user may request one or more of, for example, “Call with research Analyst,” “Most recent research,” “Initiating Coverage Report,” or “Excel Research Model.” Of course, other types of requests may be selectable, depending on how circumstances related to a company or sell-side institution may be captured and presented such as in in the drop down list 204.

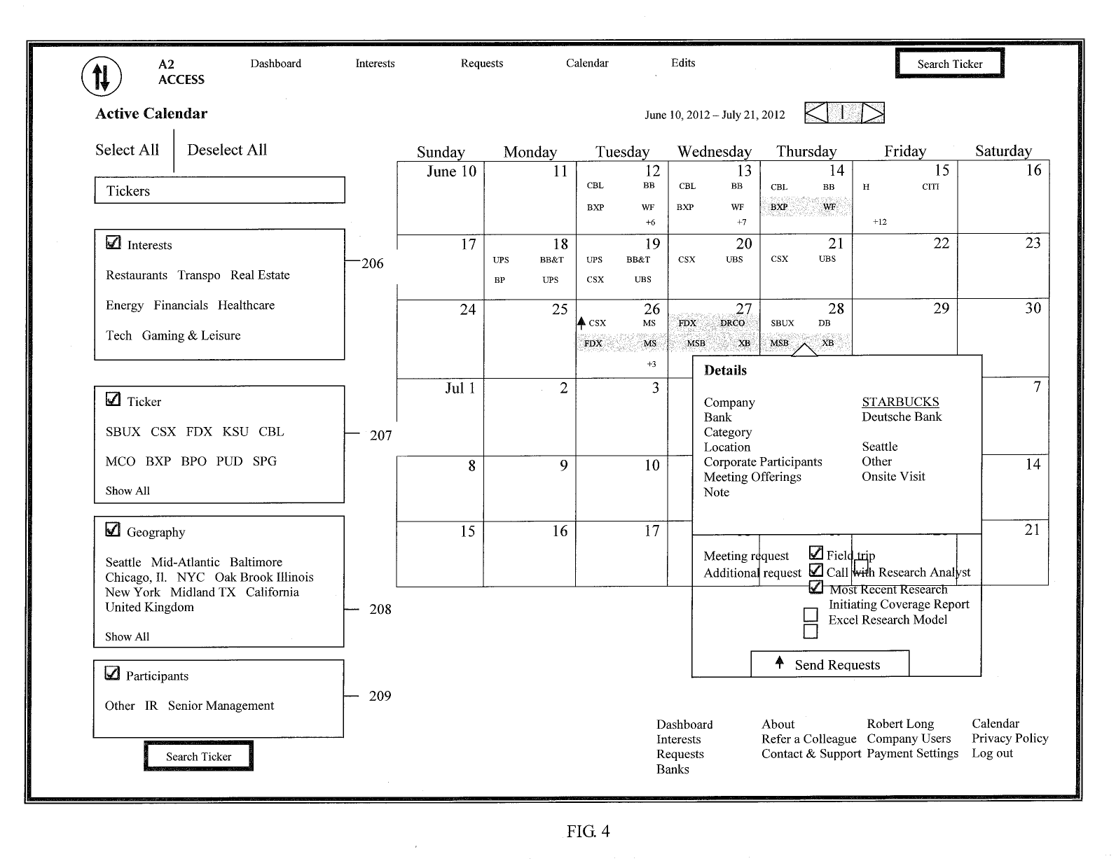

FIG. 4 is an exemplary calendar for a particular buy-side client 125a, 125b, which is shown as a displayed GUI, according to principles of the invention. The calendar may illustrate the user's interests, which tickers, participants, and geography are currently selected. By “mousing-over” or otherwise selecting a particular calendar time, details of a specific scheduled event may be expanded, such as illustrated in relation to Starbucks for the 28^{th}. The calendar may be configured to reflect pre-set filters selected such as those set for Interests 206 to reflect what sectors or industries that are of current interest to the user, Tickers 207 reflecting specific companies being followed, Geography 208 to show specific regions, cities and or countries of interest, and/or types of participants 209.

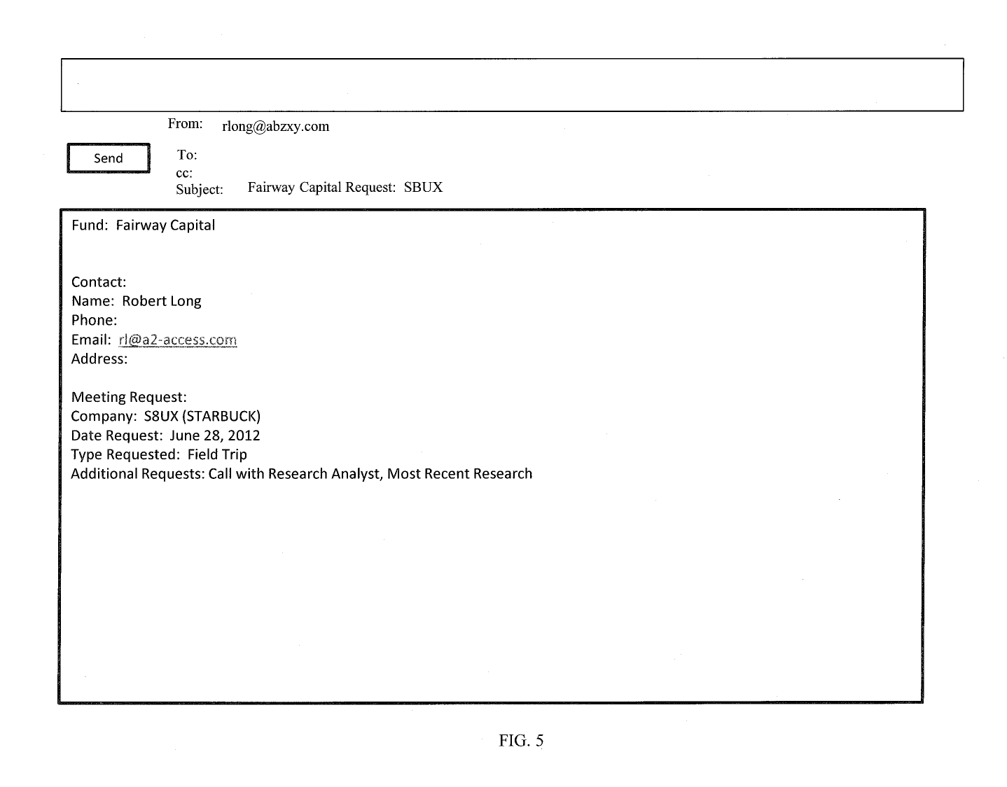

FIG. 5 illustrates an exemplary email that may be generated, typically automatically, when a buy-side client 125a, 125b selects a particular event to “attend” or participate in, according to principles of the invention. The email indicates the requesting buy-side client (“Fairway Capital”) and which company is of interest: SBUX (Starbucks), date of event (Jun. 28, 2012) and the type of event being requested (Field Trip). Also, additional requests are indicated as being of interest including “Call with Research Analyst,” and “Most Recent Research.” The email may be automatically processed and calendared by the server 110. Reports may be generated such as to show aggregated numbers of attendees by company for example. An email may be sent to the appropriate pre-selected one or more sell-side firms (such as, e.g., those in the bank coverage 204).

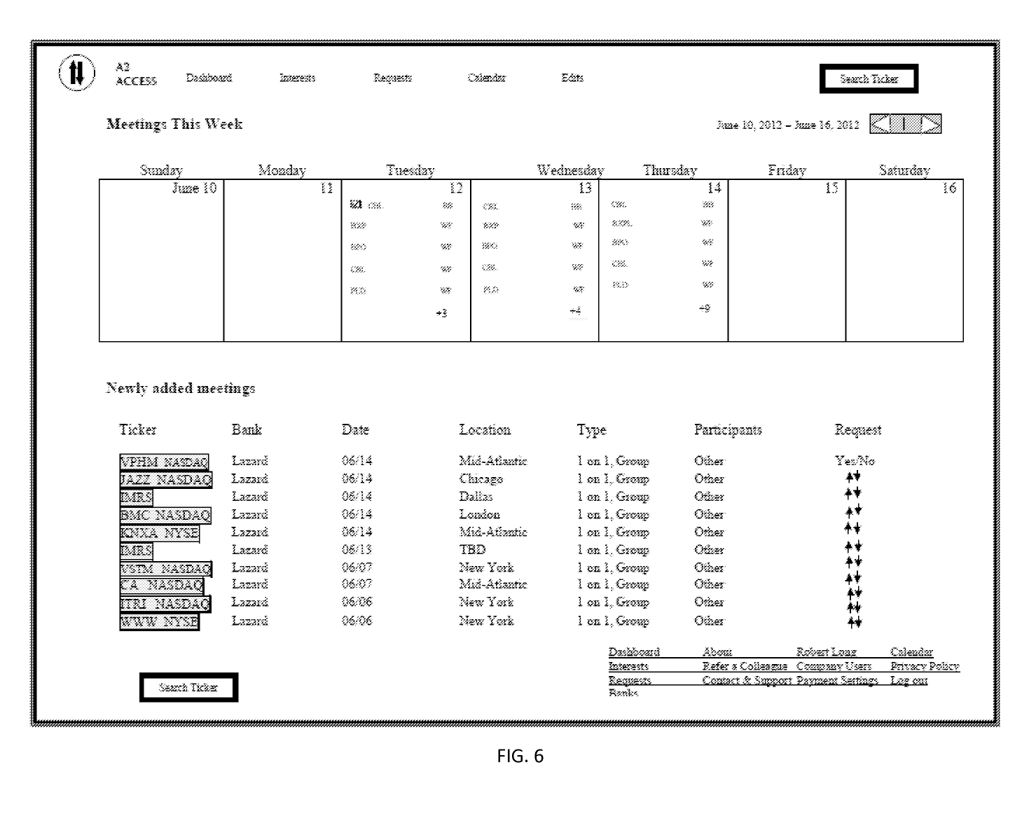

FIG. 6 is an exemplary display showing meetings scheduled for a particular week for a particular buy-side client 125a, 125b, according to principles of the invention. Also, newly added meetings are shown listing which bank, date, location, type of event and participants. A buy-side client may also request participation to an event as shown in relation to the ticker VPHM, last column.

The system 100 may be configured to aggregate events for respective buy-side clients 125a, 125b on a common calendar indicating which events they have scheduled and type of events. Also, the centralized calendaring provided by the server 110 provides a tracking service for sell-side institutions so that they can have up-to-date accounting of requests from buy-side clients and for which events buy-side clients have committed. Additionally, cancellations may be accounted for as necessary.

Bank Contact Manager

System 100 may include functionality to manage multiple sell-side contacts for a buy-side investment firm. This may include an ability to assign sell-side contacts to different investors at the same fund based on industry, location or relationship. The contacts may be managed by a central administrator and/or at the individual investor level. All of this information may be available to the administrator to provide fund managers with reports, to circulate lists amongst team members and office locations as well as maintain updates as sell-side analysts change firms and firms go out of business.

Currently firms typically have spreadsheets or other documents that they may use to keep a master list of all sell-side contacts. These lists are often outdated and incorrect which leads to confusion within the fund's team of analysts, office administrators, and managers. The system 100 contacts manager may provide functions to generate reports that can easily identify a firm's contact(s) based on investor, region, industry, etc. Investors may be able to use the contacts manager to set preferences that determine who at the sell-side firms get which request.

For example:

Johnny Investor has the following contacts at Bank A2
Tim Johnson—Europe Sales
John Smith—NYC Sales
Eduardo Toro—Brazil Sales
Brian Consumer—NYC Sales—Consumer Specialist

Johnny Investor may set preferences for any of the following (as examples):
Any corporate access request sent will go to all sales reps
Any corporate access request sent where the location is in Europe will go to Tim Johnson and John Smith only
Any event in the US will go only to John Smith.
Any research request for a consumer company will go to Brian Consumer.

The system 100 permits a common database to maintain profiles of buy-side clients 125a, 125b so that sell-side institutions 120a, 120b can target more efficiently communications to the buy-side clients 125a, 125b regarding non-deal corporate events. In this way, sell-side institutions 120a, 120b can better promote information and events related to their markets and companies they serve, and possibly encourage participation in investing opportunities. In some applications, the system 10 may also provide a database of non-sell-side institutions that may be hosting, e.g., conferences, or other industry events.

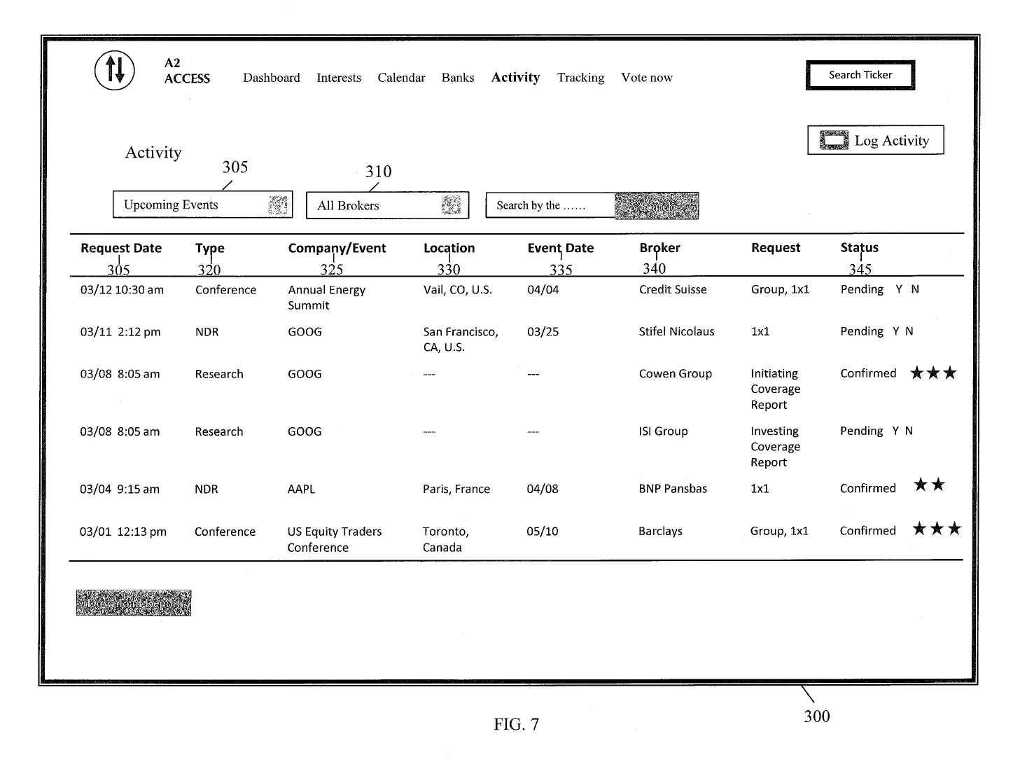

FIG. 7 is an exemplary graphical user interface 300 showing an individual investor's activity log, according to principles of the invention. The GUI 300 permits selection 305 to be displayed of upcoming events and also may permit selection 310 of a display of all brokers, or one or more specific brokers. The GUI 300 may include a display of information showing Request Date 315 and Type of event 320 such as a conference, a Research event, or a non-deal roadshow (NDR)

A column may be provided showing the Company/Event 325 to reflect, e.g., a specific conference or company involved, a column showing a Location 330 for each event, an Event Date 335 column, a column showing an associated Broker 340 for the event, and a column showing the current Status 345 such as whether or not the investor has confirmed the event, or whether confirmation is still pending.

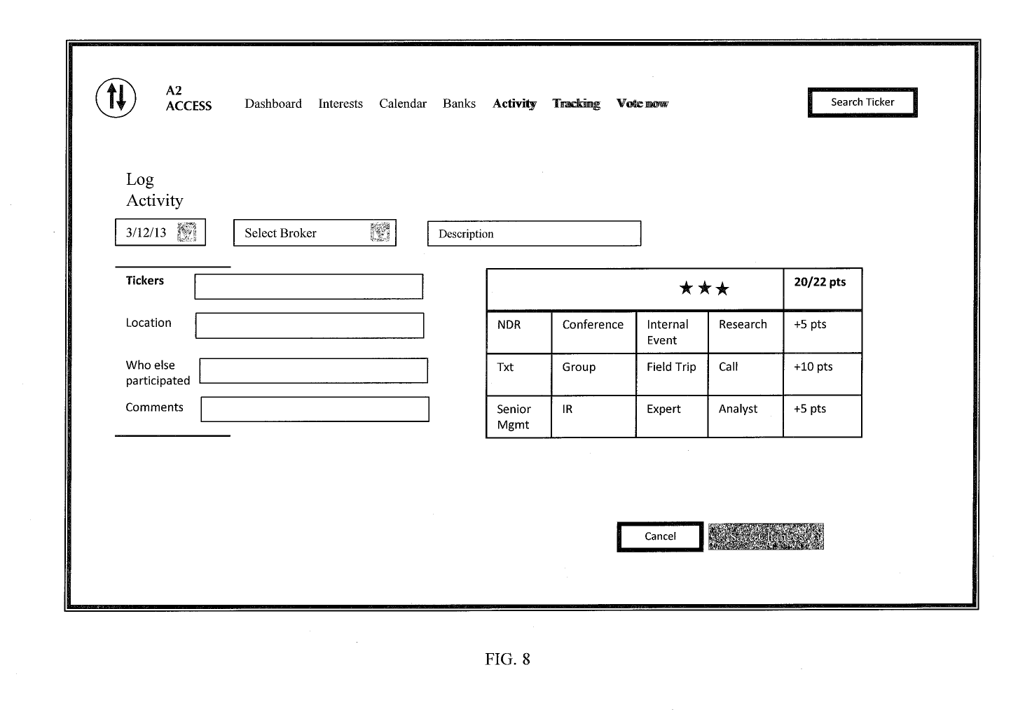

FIG. 8 is an exemplary GUI that permits a user to log requests into the system if the system did not handle the requests, according to principles of the invention. This might occur if an event has occurred outside of the system normal processing, such as, e.g., a special event, and an investor still would like to have such event accounted for by the system 100. In this way, the event may be calendared, and may also become part of a broker vote process. The “manual” input mode may permit, e.g., appropriate tickers to be entered, location of the event, who participated, type of event and point allocations.

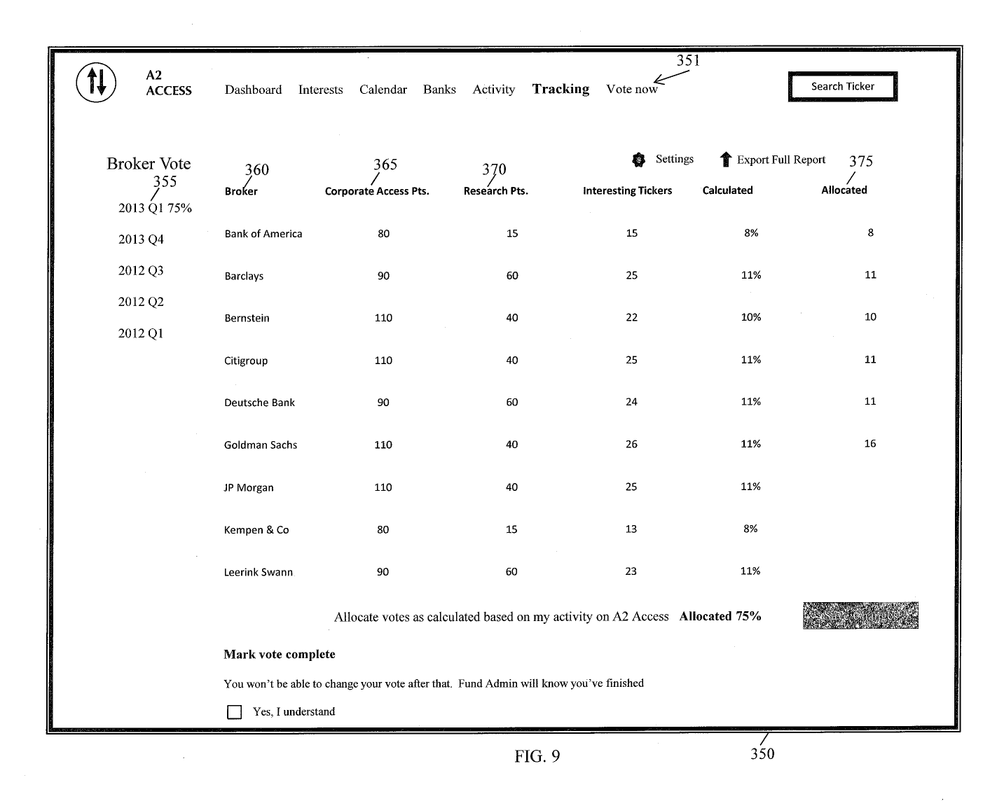

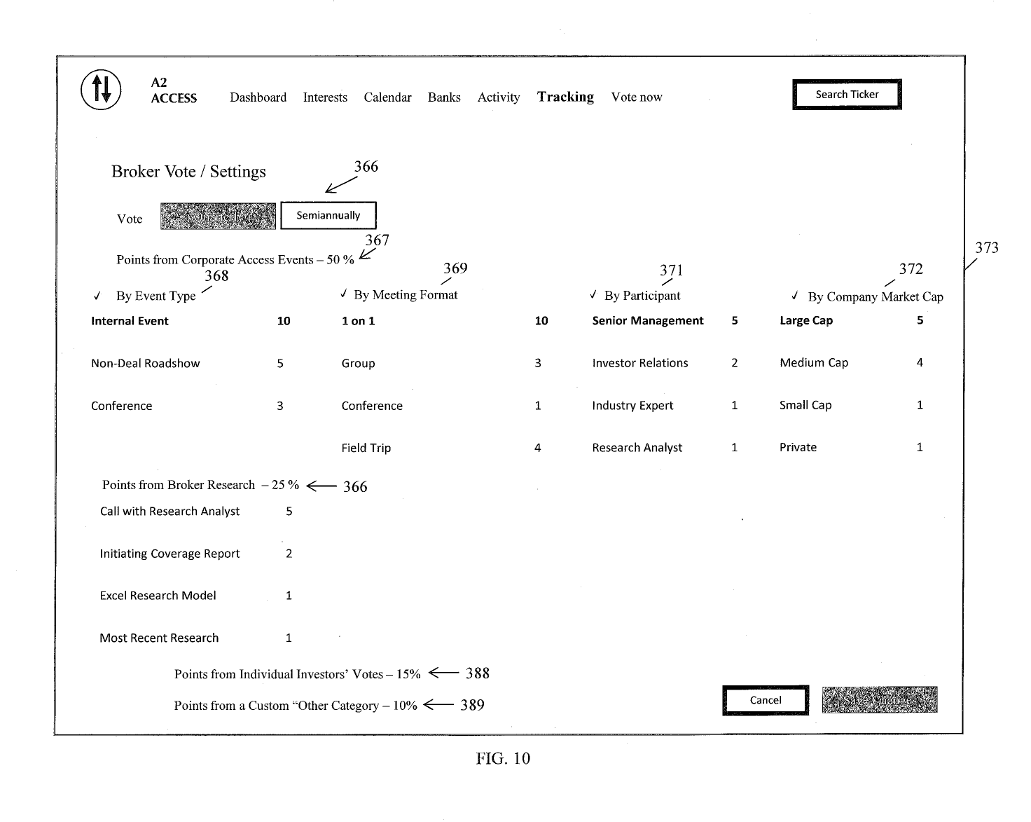

FIG. 9 is an exemplary GUI 350 showing an individual investor's input/tracking page, according to principles of the invention. This page summarizes, using row/column presentation, the current Corporate Access points 365, Research Points 370 currently accumulated for each Broker 360. The Allocated column shows the percentage of allocated commission dollars that has been assigned to each broker in the column designated Broker 360. For example, the broker Bank of America has 80 corporate access points, 115 research points and has 8% of the total commission dollars allocated to them. The broker Citigroup has acquired s 110 corporate access points, 40 research points, and 11% of the total commission dollars allocated. The total percentage of total commission dollars allocated for Q1 of 2013 is 75%, as designated by reference numeral 355. This GUI 350 permits an individual investor to provide a “broker vote” for influencing the total allocation of commission dollars among the various brokers as listed in broker column 360. A Vote button 351 may be used by a user to actually cause a broker vote to occur. A column 375 indicates a current point allocation. In this example, the broker Goldman Sachs has acquired a higher allocation percentage at 16% from this individual investor. The column labeled “Interesting Tickers” shows how many companies on a buy-side interest list (e.g., interests for a user shown in FIG. 2) is actively provided by the specific Broker 360. For example, 25 companies (under Interesting Tickers) are handled by Barclays. The Interesting Tickers counts are most often related to research services offered by the Broker 206 for the companies of the interest lists. However, a user may customize the basis for how the Interesting Tickers column is accounted based on other factors. For example, a user may set parameters that may include events and/or trades as a basis also, or instead of, the research capability of the Broker FIG. 10 is an exemplary GUI showing Broker Vote settings 373 for various sell-side offerings, according to principles of the invention. This GUI 373 allows for customized weighting in the aggregate based on how important a buy-side entity, e.g., a fund, views the specific offerings (i.e., which events are more valuable to the buy-side entity). The weighting, which may be pre-determined, shows that points from Corporate Access Events 367 will be given 50% of the weight. Points from Broker Research 366 is given 25% of the weight. Points from Individual Investors Votes 388 is given 15% of the weight. Points from Custom “Other Category” 389 is given 10% of the weight. The points associated with Corporate Access events 367 may be further subdivided into categories such as By Event Type 368, By Meeting Format 369, By Participant 371 and By Company Market Capitalization 372. Each of these categories may have specific sub-categories that may be given specific weights. For example, By Event Type 368 may include a subcategory of Internal Event which in this example has a 10% weight of the total Corporate Access Events 367 total weight of 50%.

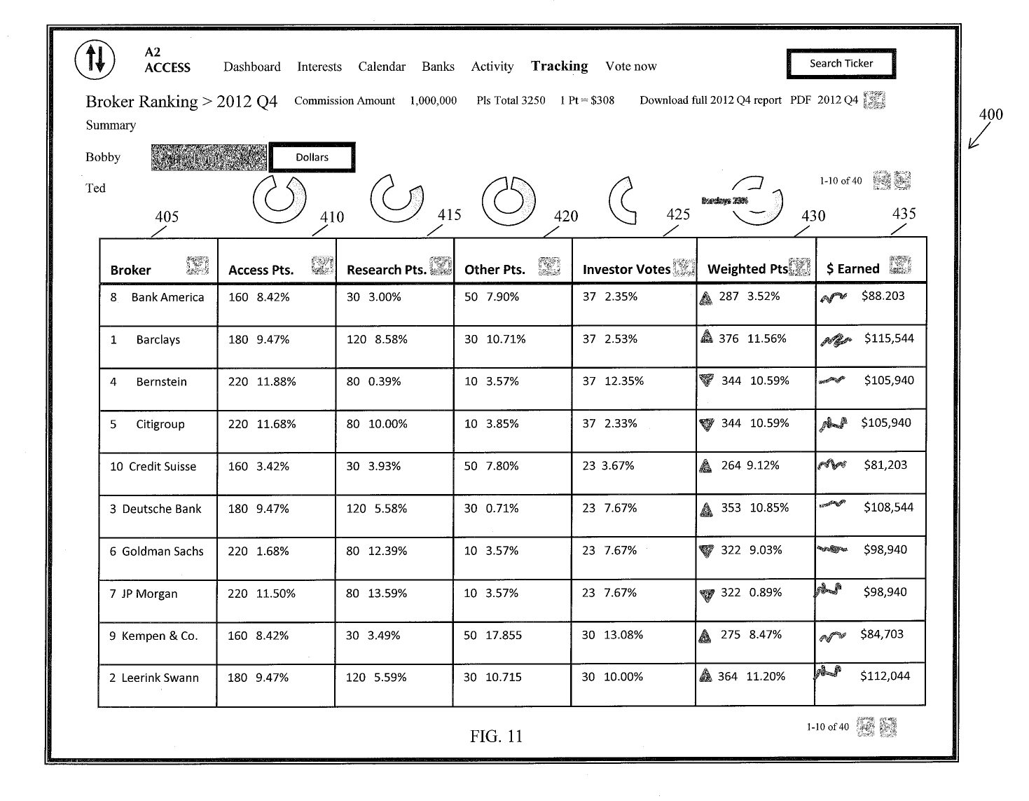

FIG. 11 is an exemplary GUI 400 showing point allocation for various sell-side offerings, according to principles of the invention. This GUI 400 is an aggregation of points for one or more sell-side entities (e.g., Brokers 405) as tracked and calculated for a buy-side entity such as a fund. This GUI 400 displays information for each Broker 405, the Access Points 410, the Research Points 415, Other Points 420, Investor Votes 425, Weighted Points 430 and Earned Commission 435. The columns may also show a percentage of the total respective points. This exemplary GUI 400 reflects the Broker Ranking for period Q4 of 2012. The system 100 computes each of the information in the columns and rows based on the noted contributing points (410, 415, 420 and 430) and also the Investor Votes 425. In the column designated Broker 405, the specific brokers are also ranked. For example, Barclays is ranked number 1, because of the highest weighted points of 376 points and dollars earned of $115,544.

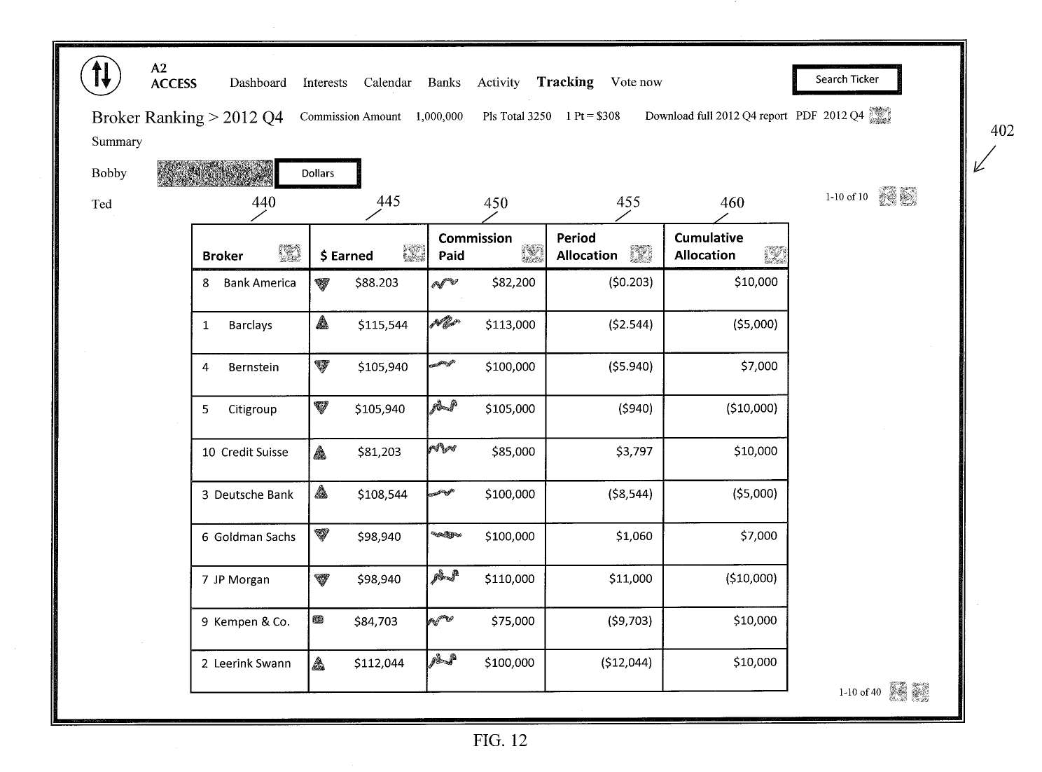

FIG. 12 is an exemplary GUI 402 showing a summary of broker ranking levels, according to principles of the invention. This GUI 402 is based in part on information of the example of FIG. 11. The GUI 402 shows the brokers in the column denoted as Broker 440, the dollars earned in the column denoted $ Earned 445, Commission Paid 450, Period Allocation 455 and Cumulative Allocation 460 for each broker for the period. This GUI 402 is for period Q4 of 2012. The $ Earned 445, Commission Paid 450 and Cumulative Allocation 460 are tracked and calculated by system 100 (e.g., by server 110)

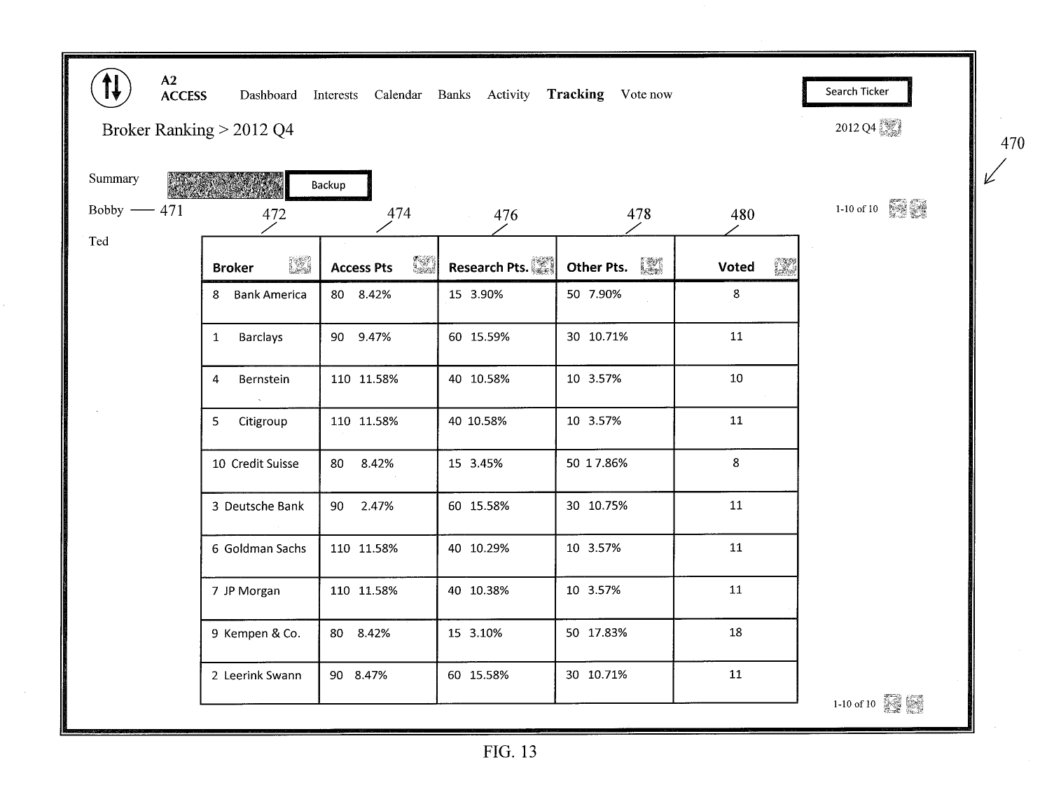

FIG. 13 is an exemplary GUI 470 showing investor level rankings, according to principles of the invention. In this example, the GUI 470 shows ranking data for investors Bobby 471. Bobby has voted for each broker of the Broker 472 column, which is reflected in the column, denoted Vote 480. Also shown are Access Points 474, Research Points 476 and Other Points 478 for each broker. This information is used in the aggregation and computing of the commissions for the brokers, such as by server 110.

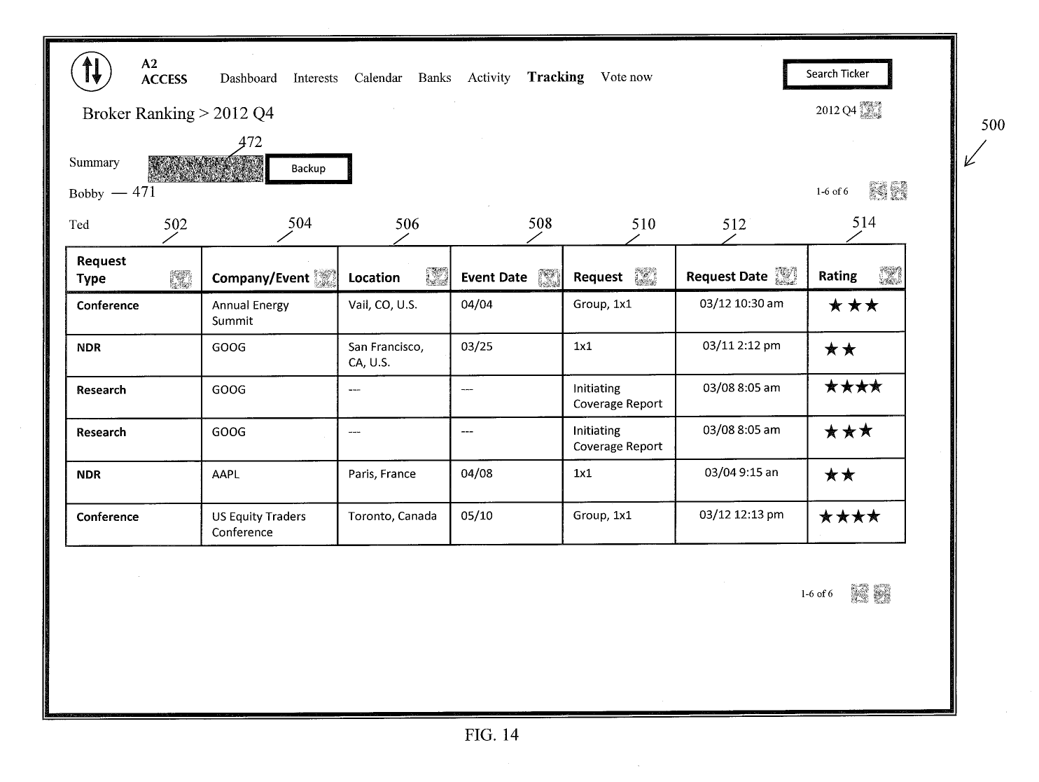

FIG. 14 is an exemplary GUI 500 showing underlying activity that contributed to the information displayed in FIG. 13, according to principles of the invention. This is for one inventor; data for other investors may also be maintained by the system 100. GUI 500 shows data associated with investor Bobby 471. The data includes Request Type 502, Company/Event 504, Location 506, Event Date 508, Request 510, and Request Date 512 and Rating 514. This is supporting information that might also be delivered for audits or management reporting, for example.

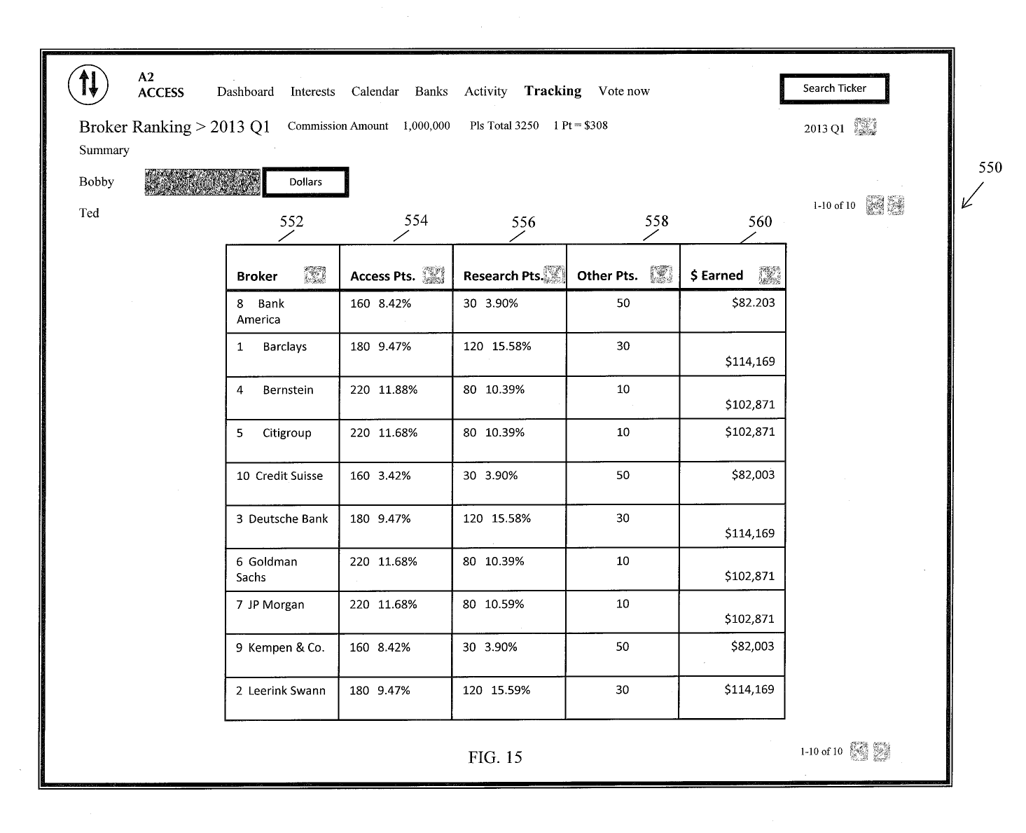

FIG. 15 is an exemplary GUI 550 showing a fund level view based on the GUI of FIG. 13, except based on multiple investors, according to principles of the invention. The columns labeled Broker 552, Access Points 554, Research Points 556, Other Points 558 is similar to like columns of FIG. 13, but the data is based on input from multiple individual investors. The column labeled $ Earned 560 is the amount earned for each broker.

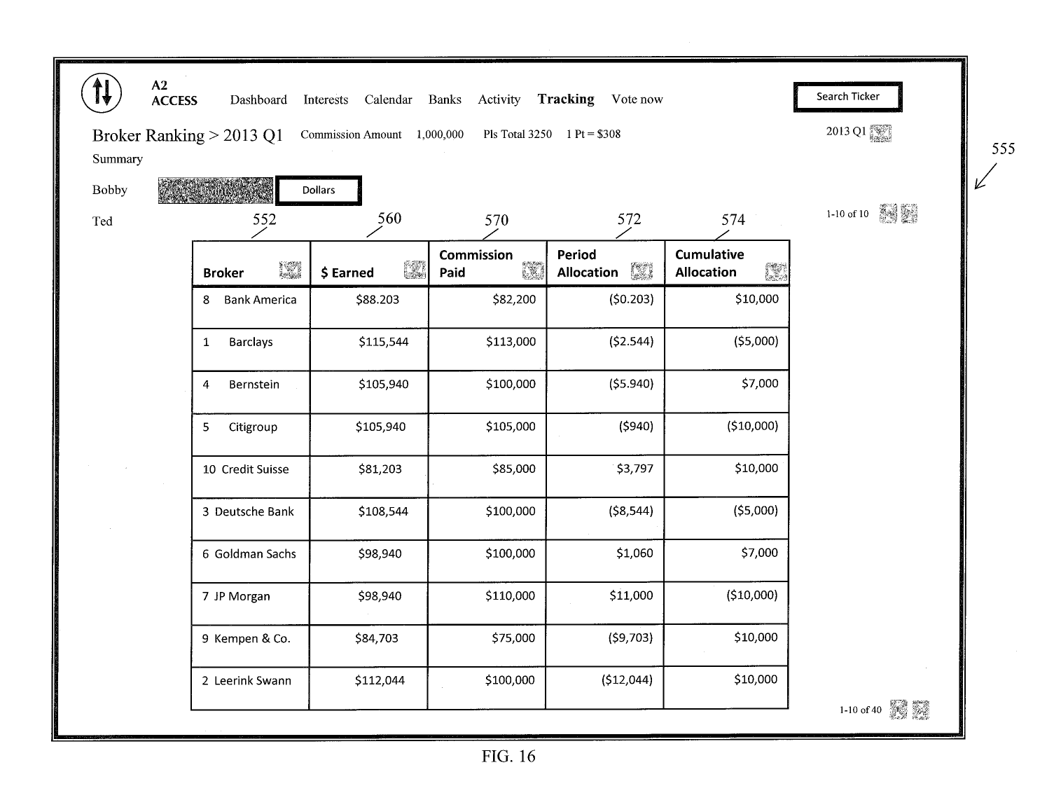

FIG. 16 is an exemplary GUI 555 similar to GUI 550 of FIG. 15 except it is presented in dollar amounts, according to principles of the invention. The columns include Broker 552, $ Earned 560, Commission Paid 570, Period Allocation 572 and Cumulative Allocation 574.

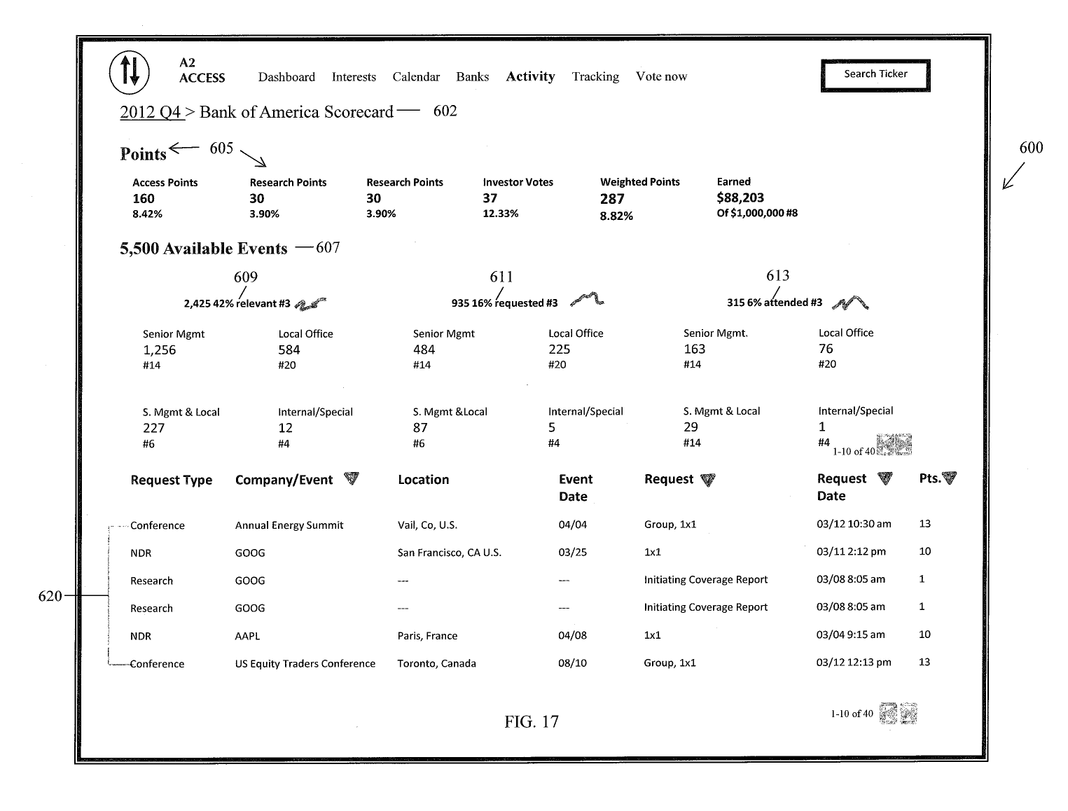

FIG. 17 is an exemplary GUI 600 showing a scorecard for an exemplary Broker 602, according to principles of the invention. The GUI 600 is for period Q4 of 2012. The Broker 602 is shown as Bank of America. The GUI 600 summarizes the information related to Bank of America as reflected in FIGS. 15 and 16. Shown are Points 605 by Access Points, Research Points and Weighted Points. Also shown are the Inventor Votes (aggregated) and dollars Earned ($88,203). A percentage of each category is also shown. These values may be tracked and computed by the system 100, such as by server 110.

GUI 600 also shows the Available events 607 that was associated with Bank of America, broken down into categories including relevant events 609, requested events 611 which shows how many events that were requested actually were scheduled by the sell-side firm, and events attended 613. Also shown how many events were with senior management, or at a local office. A field 620 for showing Request Types such as e.g., research or conference, Company/Event such a, e.g., a company name or conference, Location of the event, Event Date, Request, Request Date and Points allocated to the particular Company/Event may also be displayed. In some implementations, FIG. 17 may also be configured to show the results of the Broker 602 by specific buy-side office or by buy-side firm region. For example, some buy-side investors in different offices of the same firm may have relationships with Broker 602 in different offices. The results of FIG. 17 may be further refined to show results by specific buy-side office or region. In this way, the points may be shown related to the specific offices or specific regions of the buy-side firm. This may be useful, e.g., in attempting to get a better relationship and/or performance from the Broker 602, if necessary, in different locations.

The system 100 may be configured to maintain corporate access data and maintains inventor interest lists so that metrics may be computed and displayed to include, at least in part:
how each sell-side firm's offerings matched inventors interest
how many of the meetings the inventors requested, were granted
of the granted meetings, how many were attended

Additionally, metrics generated by system 100 may include
how many meetings were with corporate management
how many meetings were on the investor list
How many meetings a sell-side firm specifically organized for a particular buy-side entity or firm.

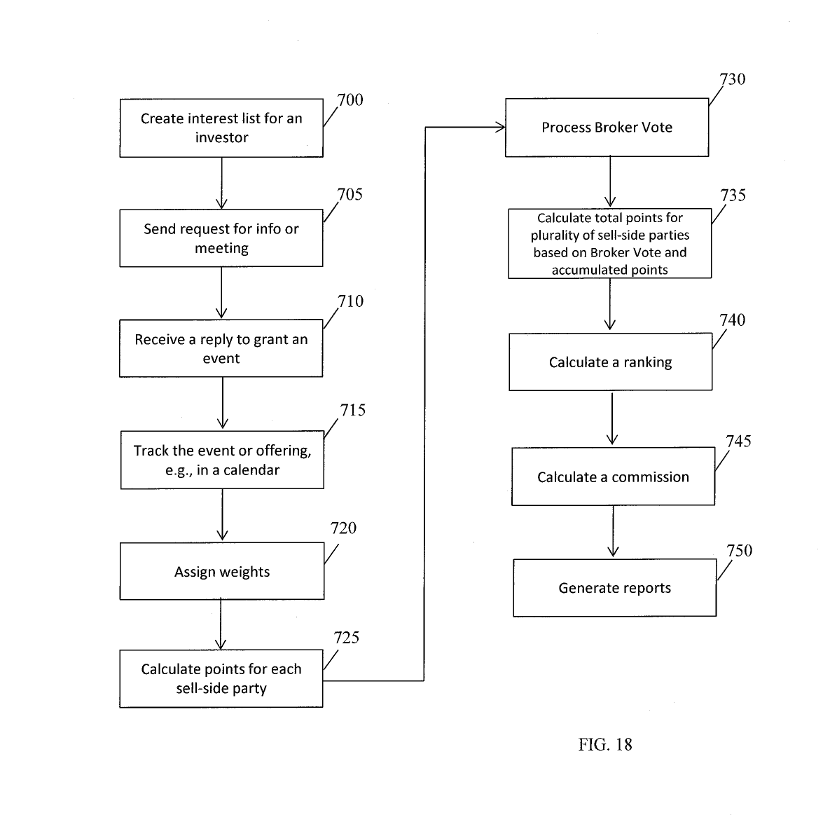

FIG. 18 is a flow diagram showing an example process, the steps performed according to principles of the invention. The process of FIG. 18 may be performed by a system such as that shown in relation to FIG. 1, and may be supported by the GUIs of FIGS. 2-17. At step 700, an interest list may be created for one or more users (e.g., investors) associated with a buy-side financial party (such as, e.g., an investment firm). The interest list may be similar to the lists shown in FIG. 2, for example. In some implementations, an Interest List may be configured to be shared among a plurality of users, and/or the Interest List may be subscribed to by a plurality of users. In this way a common interest list may be shared, such as, e.g., in one buy-side firm location. The shared interest list may be managed by a designated person, or may be managed by any or the users. This may be controlled by parameters as to who may manage the interest list.

At step 705, a request may be sent to one or more sell-side parties (e.g., broker, bank, or the like) for requesting information (e.g., information on one or more specific companies) and/or requesting a meeting associated with one or more specific companies. The request may be done by email and may be automatically logged and tracked by system 100. At step 710, a response may be received that may or may not include an indication of a granted event in response to the request. The request may have been to request confirmation to attend an event. At step 715, the event may be tracked and logged into a calendar (e.g. calendar shown in FIG. 4). At step 720, weights may be assigned or predetermined to weight a point system for rating one or more sell-side parties. The weights may be assigned to corporate access points, research points, and/or broker voting points. Moreover, the weighting may be further defined by type of event, by meeting format, by participant, by company market capitalization, custom points, and/or broker research (see, e.g., FIGS. 9-11). At step 725, points may be calculated for each sell-side party based on points accumulated (e.g., based at least in part on any of corporate access points, research points). At step 730, a broker vote may be processed for one or more brokers associated with the buy-side party, for the one or more sell-side parties. At step 735, calculation of total points for a period of time may be performed for each of the sell-side parties based on the broker votes and the accumulated points (e.g., corporate access points, research points and any other points). At step 740, a ranking is calculated for each of the sell-side parties based on the total aggregated points. A separate ranking of the sell-side parties for each individual investor may be calculated based on points associated with each individual investor (i.e., an investor view). At step 745, a commission may be calculated for each sell-side party. At step 750, reports may be generated showing one or more of: ranking, points, commissions, investors, firm view, investor view, and the like. The reports may be for a specific time period and/or an aggregation report over a time period.

The steps of processes such as FIG. 18, including the processing of the input and output of the various GUIs described herein, may be implemented on computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). The computer program code may be configured as a computer program product such as on a memory, disc or DVD, for example, which when read and executed by a computer processor, executes the steps stored therein. The graphical user interfaces (GUI) described herein may be displayed on appropriate user display devices and input may be received by appropriate user input devices. The GUIs described herein may also represent steps for performing the activity described by the respective GUI, including any calculations required to generate values shown on the respective GUI. The Figures showing graphical user interfaces (GUIs) may also represent the software components in combination with appropriate computing hardware such as server 110 for initiating the displaying of the respective GUI and for receiving any input from a user. The flow charts herein such as FIG. 18 may also represent a block diagram of the associated component that is configured to perform the steps thereof.

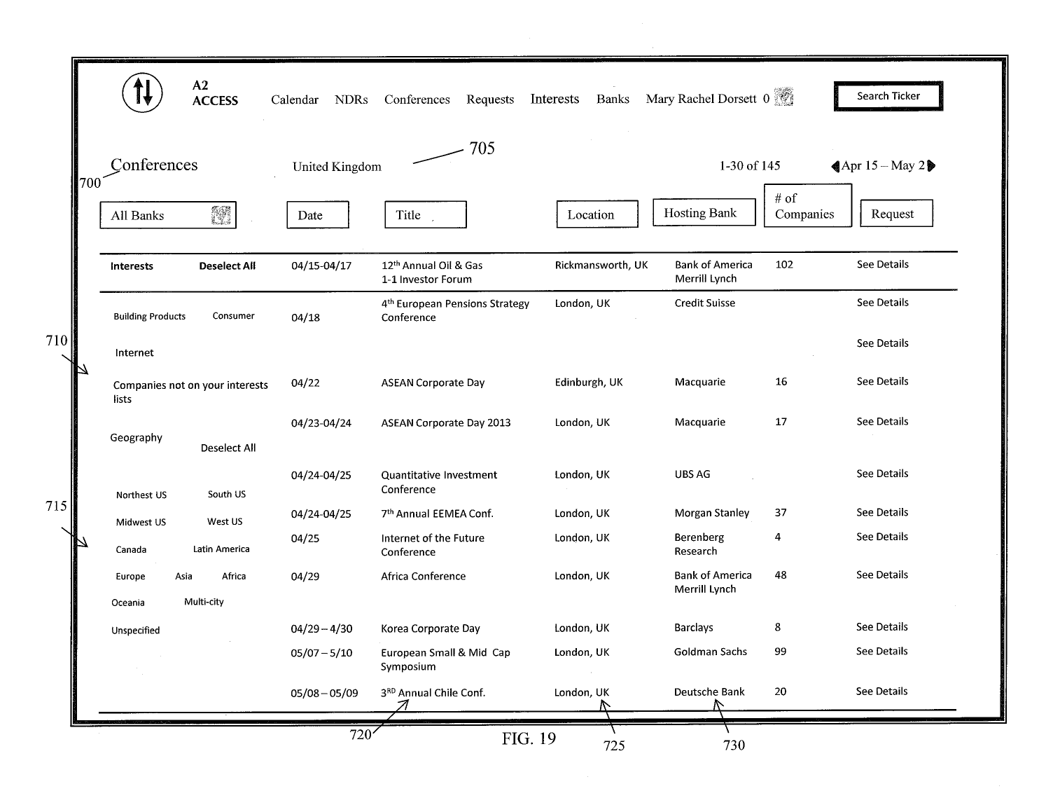

FIG. 19 is an exemplary GUI showing a listing of conferences by geographic location, according to principles of the invention. The GUI of FIG. 19 may permit a user to search for an event such as a conference 700 for a specific geographic location such as the United Kingdom 705. A user such as an investor may set parameters such as area of interest generally denoted by reference numeral 710, and may set a parameter related to general geographic area 715. The system 100 may search for matching events, cross-reference the events and the interest list, and may display the results such as the title 720 of the conferences, location 725 of the conferences and the hosting entity 730 such as a hosting bank. The cross-referencing may include cross-referencing based on at least one of: a specific industry, a specific company, a geographic region, a public company and a private company. A date of the conferences may be listed as well as the number of companies that will be represented at the event. The system 100 may search its database 115 which may maintain the information shown in FIG. 19 (and the information shown in all the other GUIs herein) in a consolidated manner, and which may be selectively searched by parameters by the user.

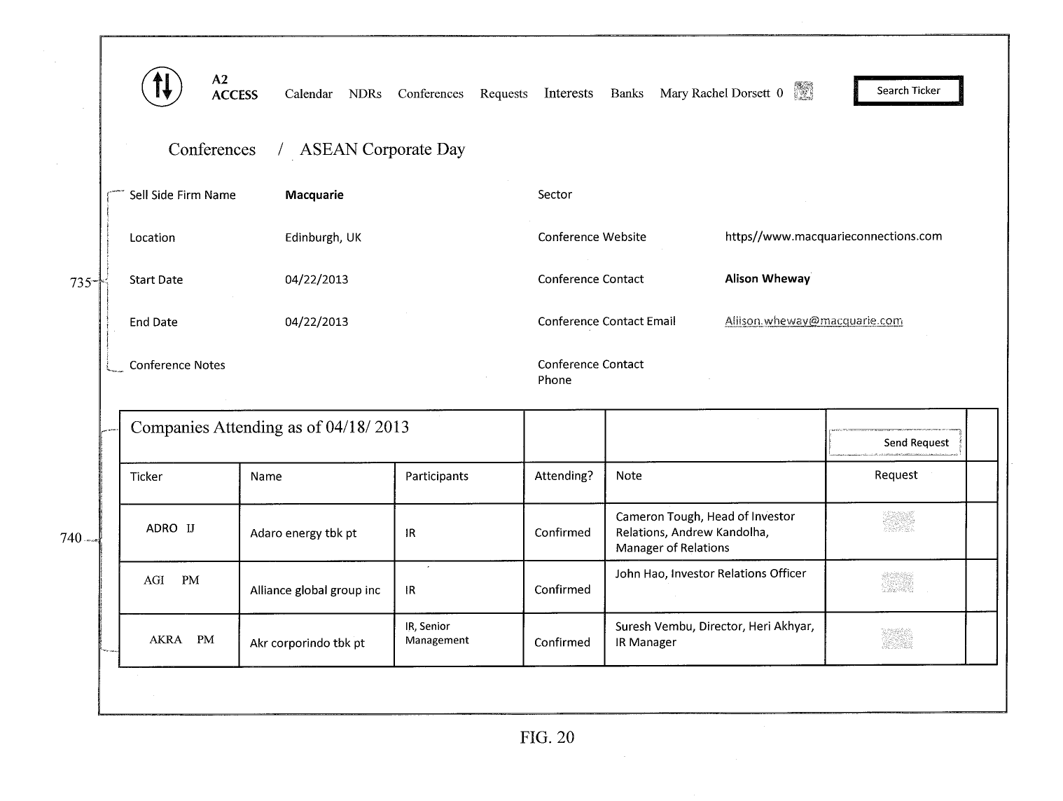

FIG. 20 is an exemplary GUI showing detailed information of a selected conference, according to principles of the invention. FIG. 20 is a more detailed display of a conference that may be selected from the GUI of FIG. 19, in this example the conference titled “ASEAN Corporate Day” from column 720, or the Hosting Bank “Macquarie” from column 730 of FIG. 19 was selected by a user. The GUI of FIG. 20 shows more detailed information 735 related to the ASEAN Corporate Day such as the start date and end date, conference contact, conference contact information (e.g., phone or email), and/or conference website. The GUI of FIG. 20 may also display various companies 740 that may be attending including, e.g., the tickers symbols, name of the companies, type of participants such as senior management or institutional representative, and if attendance has been confirmed. A field for notes may be included to convey more information related to the event. If necessary, a communication may be generated by selecting: a “Request” to request more information related to the specific event.

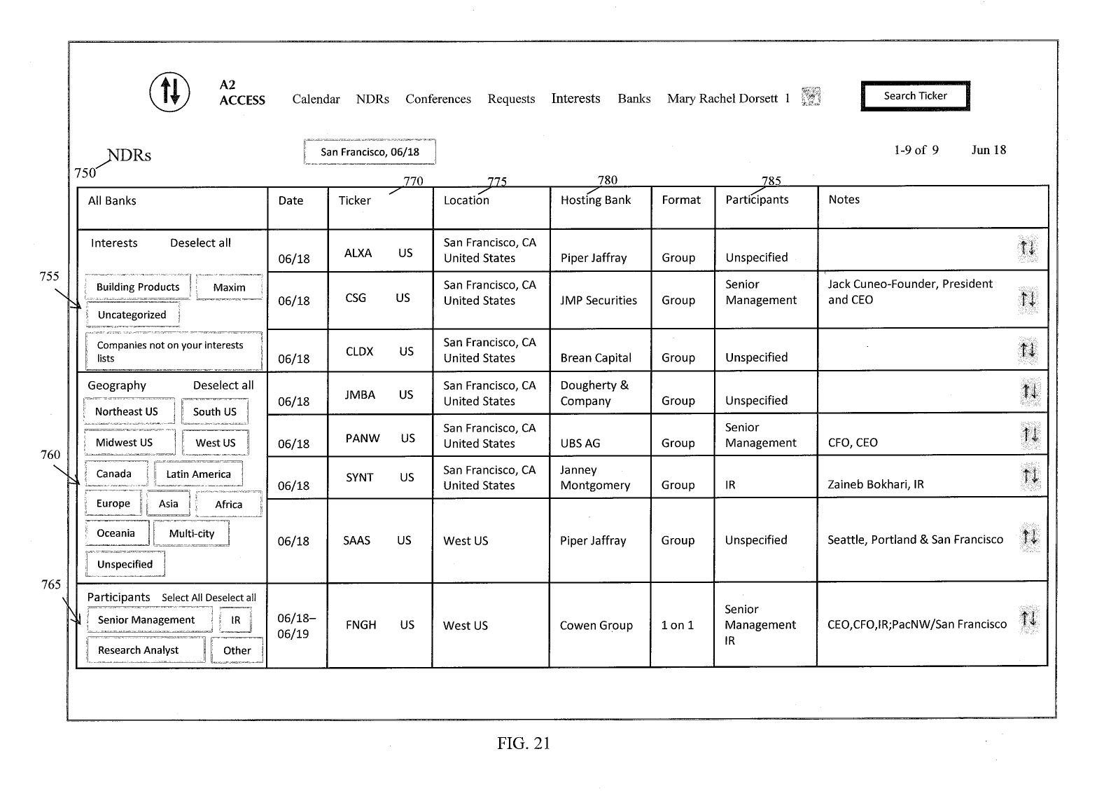

FIG. 21 is an exemplary GUI showing a listing of non-deal roadshows (NDR) for a selected geographic area, according to principles of the invention. The GUI of FIG. 21 displays events related to NDRs 750. In this example, the display is for all banks related to the Interest Group 755, for San Francisco, which may be selected by geography options 760 and perhaps by specific types of participants 765. The information may be displayed in column fashion. The columns may show the date of the NDRs, the tickers 770 of the companies, the location 775, hosting entity 780, and participants 785. The system 100 may search for information matching the selected parameters from the database 115 for display such as shown in the GUI of FIG. 21.

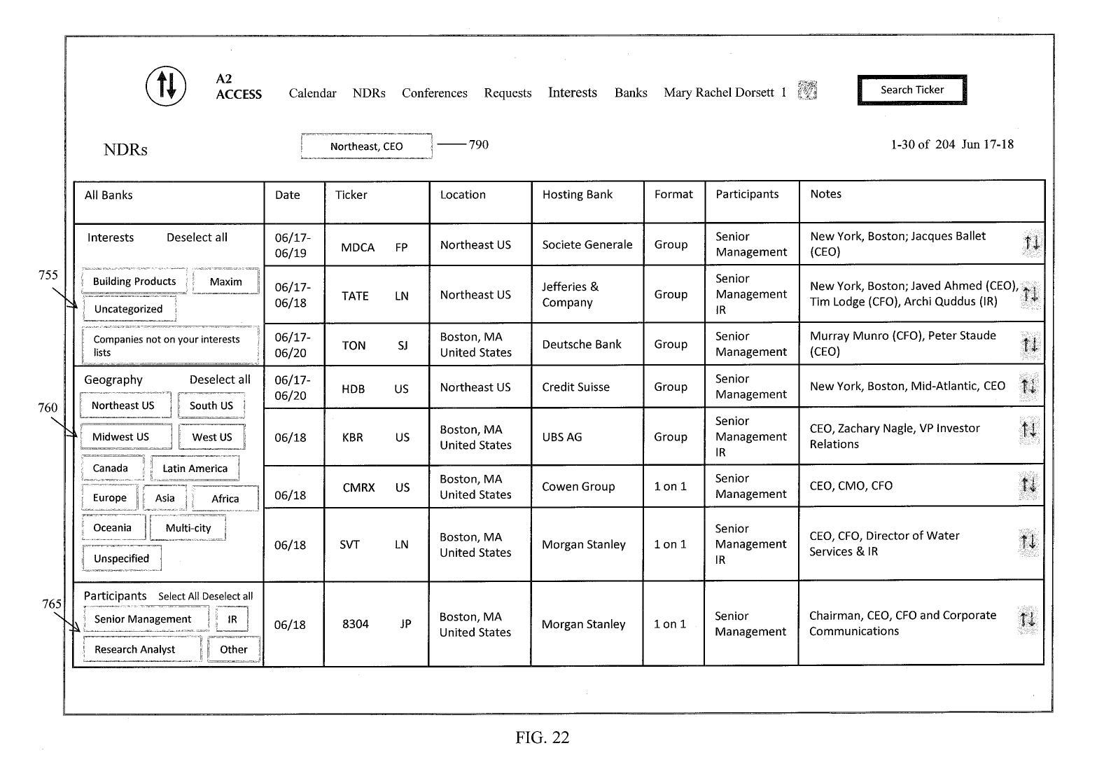

FIG. 22 is an exemplary GUI showing a listing of non-deal roadshows (NDR) for a selected geographic area, according to principles of the invention. The GUI of FIG. 22 is similar to the GUI of FIG. 21, except for a geographic region of northeast and participant type of CEO, as indicated by reference numeral 790. A user may select at will one or more parameters to search on. A search may be performed on different categories of information by selecting search parameters, such as, e.g., geography, type of event, hosting entity, participants involved, dates, ticker, and interest areas. Information related to the different categories may be accumulated and maintained by the system 100 such as by database 115. The information, e.g., geography, type of event, hosting entity, participants involved, dates, tickers, and interest areas related to the different categories may be accumulated automatically by system 100 such as whenever communications occur between a requester, such as a buy-side investor, and a sell-side entity.

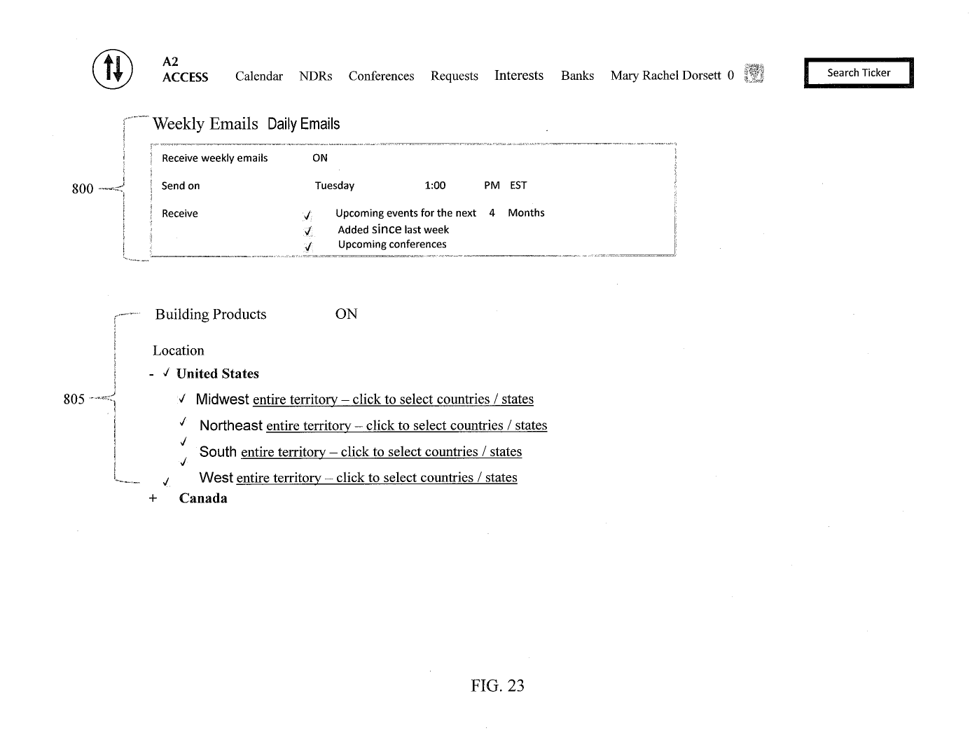

FIG. 23 is an exemplary GUI showing exemplary settings for receiving emails, according to principles of the invention. The GUI of FIG. 23 shows that a user may select parameters for sending and/or receiving emails. In this example, parameters for controlling weekly emails 800 may be displayed. Moreover, an area of interest and geographic location parameters 805 may be displayed for potential user review and alteration of the settings.

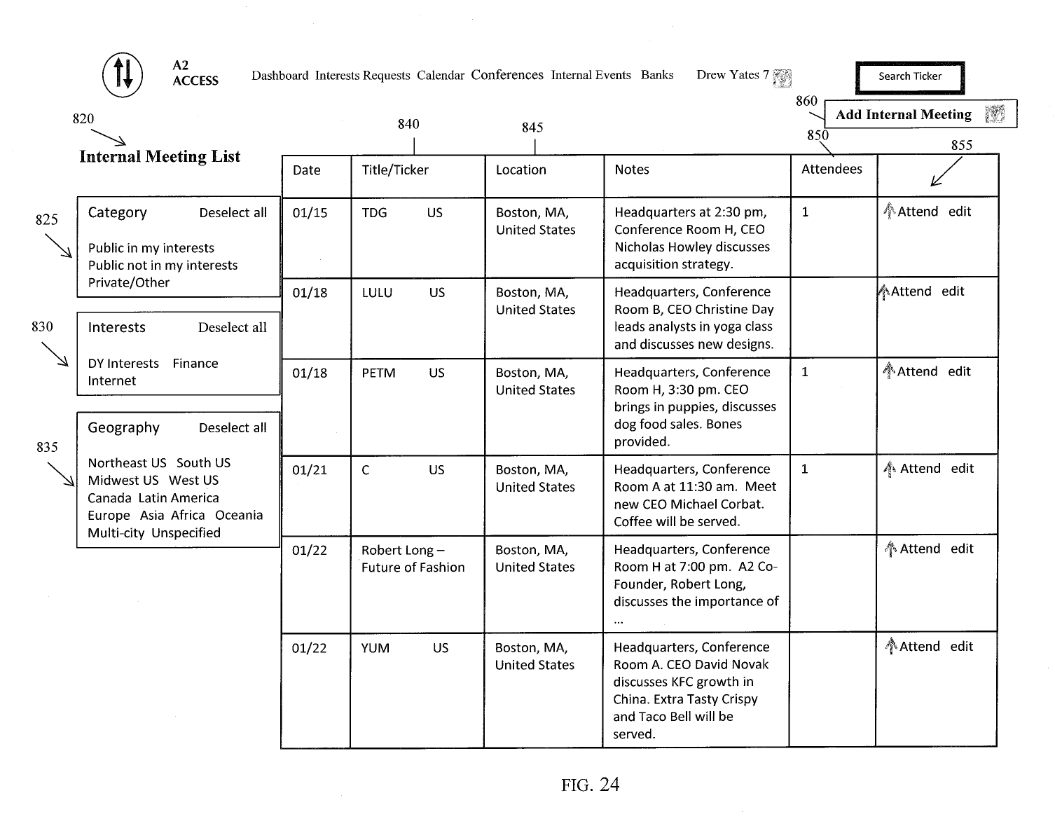

FIG. 24 is an exemplary GUI showing an internal meetings list 820. In some implementations, a buy-side firm (e.g., a larger mutual fund) may themselves host events. In this scenario, the buy-side firm may create an events list themselves and have the system 100 track and manage communications with potential companies, attendees and/or participants, and calendar events and log responses. FIG. 24 is configured to permits a user to set a category 825 for searching/viewing such as “public in my interests,” “public not in my interests” and “private/other.” An Interests 830 parameter area that may be set and a Geography 835 parameter area. The display may include a date column, a Title/Ticker column 840, a Location 845 column, a notes column, and a column reflecting the number of attendees 850 currently confirmed. A selection 855 may also be provided for a user to confirm attendance at an event.

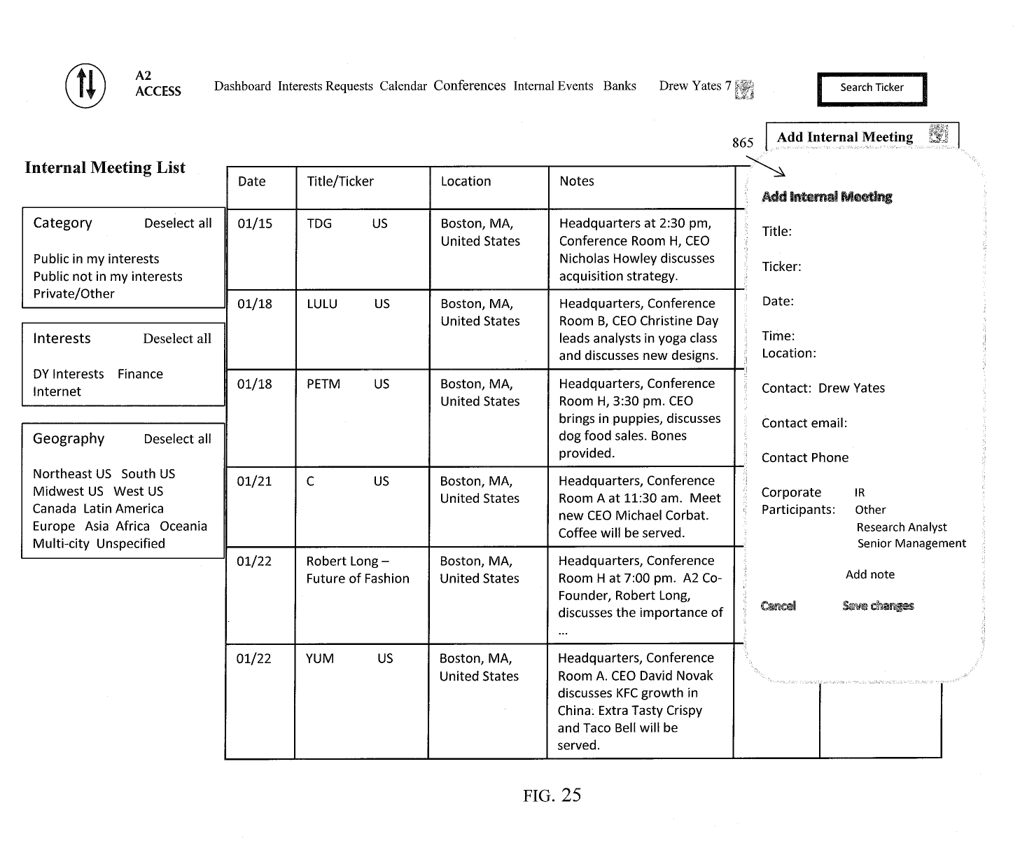

A user may add a new Internal Meeting to be included on the internal meetings list 820. This may be accomplished, e.g., by selecting a Add Internal Meeting button 860, which may present a new drop down 865 such as shown in FIG. 25. The drop down 865 may be configured to permit entry of a new internal meeting event with supporting information such as dates, ticker, location, time, contact information, and the like.

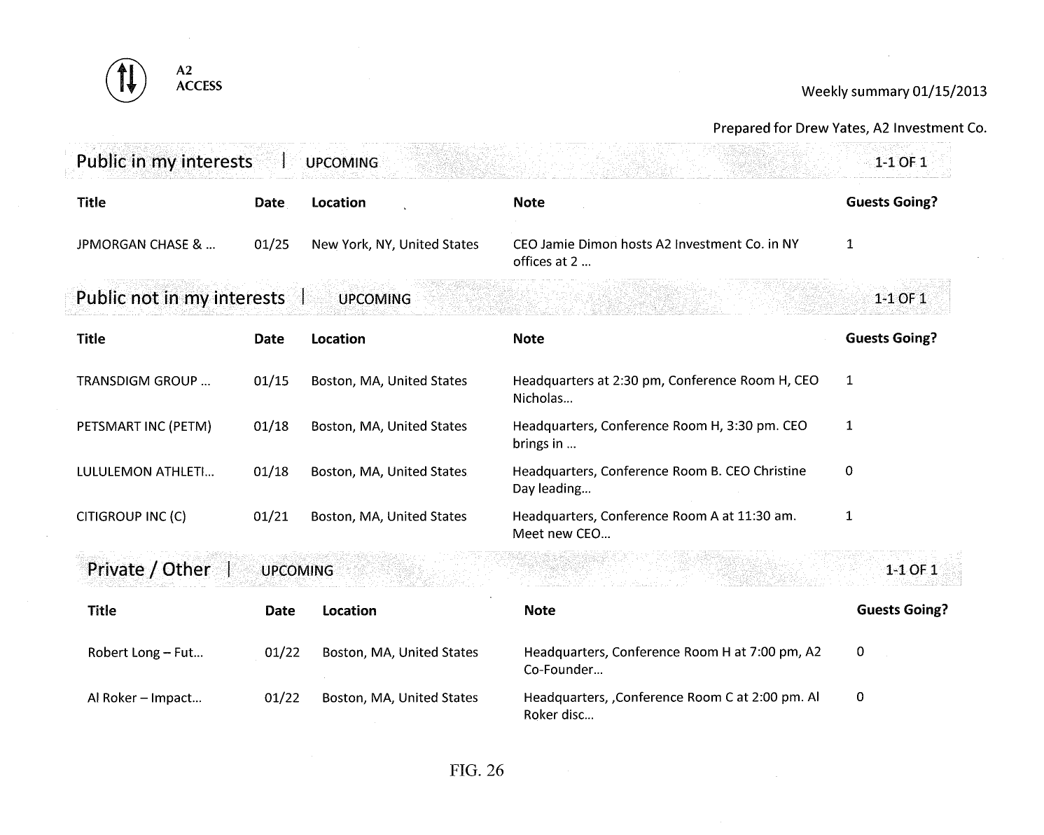

FIG. 26 is a GUI showing a listing of weekly (or other time period) emails that a user may receive related to the Internal meetings lists, e.g., of FIGS. 24 and 25. This GUI may be provided by the system 100 for a particular user and may show emails from companies by time period in different categories such as “public in my interests” “public not in my interests,” private/other.” This permits a user to track which companies have responded and may show the number of guests.

The system 100 may be configured to automatically accumulate information related to events and stores the information, such as in database 115, for subsequent recall by a user. The events may be requested/searched by a user based on parameters, e.g., geography, type of event, hosting entity, participants involved, dates, ticker, and interest areas, and the like. The events may be scheduled and confirmed by a user through one or more GUIs as shown herein. The information stored in database 115 may be searched by a user based on one or more of the parameters. Communications, e.g. by email, may be performed and logged by the system 100, perhaps as directed by a user. Responses to communications may be automatically logged and calendared. In this way a system 100 is provided that aggregates information (e.g., geography, type of event, hosting entity, participants involved, dates, ticker, and interest areas, and the like) that may be searched, with communications automatically tracked and results calendared as relevant. Moreover, manual entry of data, such as whether or not an event was attended, may be supported by the system 100.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed is:

1. A system for providing targeted communications between a first financial party and at least one second financial party, the system comprising:
a component executing on a computer platform to track at least one offering from a plurality of sell-side financial parties;
a component executing on the computer platform to calculate a quantity of the at least one offerings that was requested by a requesting buy-side investor and granted by at least one of the plurality of sell-side financial parties or a hosting party; and
a component executing on the computer platform to record and report how many of the calculated quantity were attended by the buy-side investor.

2. The system of claim 1, further comprising:
a component executing on the computer platform to receive at least one broker vote; and
a component executing on the computer platform to calculate a broker ranking based at least in apart on the broker vote.

3. The system of claim 2, further comprising a component executing on the computer platform to calculate corporate access points for the plurality of sell-side financial parties.

4. The system of claim 3, further comprising a component executing on the computer platform to calculate research points for the plurality of sell-side financial parties;

5. The system of claim 4, further comprising a component executing on the computer platform to calculate a commission for the plurality of sell-side parties based on at least one of: the broker vote, the research points and the corporate access points.

6. The system of claim 5 wherein the calculated commission is based on the broker vote, the research points and the corporate access points.

7. The system of claim 5, wherein the broker vote, the research points, and the corporate access points are weighted.

8. A computer-implemented method for providing targeted communications between a first financial party and at least one second financial party, the method comprising the steps of:
creating an interest list for at least one investor associated with the first financial party;
sending at least one request for information over a network to a plurality of second financial parties maintained in the interest list;
calendaring at least one event based on received information from the plurality of second financial parties;
recording whether or not the at least one event was attended;
allocating points to at least one of the plurality of second financial parties based on a result of the at least one event; and
calculating and displaying a commission allocation based on at least in part the allocated points,
wherein the steps of creating, sending, calendaring, recording, allocating, and calculating are performed by a computer.

9. The computer-implemented method of claim 8, wherein the result indicates one of: a meeting occurred with a management personnel from the at least one of the plurality of second financial parties and attendance occurred at the at least one event.

10. The computer-implemented method of claim 9, wherein the at least one request is a plurality of requests and further comprising the step of allocating points to the plurality of second financial parties based on a total of meetings that each of the plurality of second financial parties granted based on the plurality of requests.

11. The computer-implemented method of claim 10, further comprising allocating points to the plurality of second financial parties based on whether or not the at least one event is on the interest list.

12. The computer-implemented method of claim 8, further comprising processing a broker vote from the at least one investor associate with the first financial party and calculating an amount of points to be allocated to the plurality of second financial parties based on the broker vote.

13. The computer-implemented method of claim 12, wherein the at least one investor associated with the first financial party is a plurality of investors associated with the first financial party and further comprising processing a broker vote from each of the plurality of investors and calculating cumulative points for each of the plurality of second financial parties based at least in part on the broker vote from each of the plurality of investors.

14. The computer-implemented method of claim 13, further comprising calculating a total point allocation for each of the plurality of second financial parties based on the cumulative points calculated based at least in part on the broker vote from each of the plurality of investors and also based in part on the allocated points for the plurality of second financial parties.

15. The computer-implemented method of claim 14, wherein the cumulative points and the allocated points are weighted based on a predetermined weight assignment.

16. The computer-implemented method of claim 14, further comprising calculating a compensation for each of the plurality of second financial parties based on the total point allocation.

17. A computer-implemented method for providing targeted communications between a first financial party and at least one second financial party, the method comprising the steps of:
assigning points by a first financial party or by individual investors associated with the first financial party to a plurality of sell-side financial parties;
accumulating points for each of the plurality of sell-side financial parties; and
calculating and reporting a commission allocation for each of the plurality of sell-side financial parties based on at least in part the accumulated points,
wherein each of the steps are performed by a computer.

18. The computer-implemented method of claim 17, wherein points are accumulated based on a number of events scheduled based on requests made by the individual investors.

19. The computer-implemented method of claim 17, wherein points are accumulated based on a number of events scheduled based on requests made by the individual investors.

20. The computer-implemented method of claim 17, wherein the points are accumulated based on whether a scheduled event was attended by one of the individual investors.

21. The computer-implemented method of claim 17, wherein the points are accumulated based on whether a scheduled event was attended by a management personnel from one of the plurality of sell-side financial parties.

22. A computer-implemented method for providing targeted communications between a first financial party and at least one second financial party, the method comprising the steps of:
searching for at least one scheduled event by at least one of: meeting type, geography, and a predetermined interest list;
sending at least one request for information over a network to at least one of a plurality of second financial parties; and
calendaring at least one scheduled event based on received information from the at least one of the plurality of second financial parties;
wherein the steps of searching, sending and calendaring are performed by a computer.

23. The computer-implemented method of claim 22, further comprising the steps of:
recording whether or not the at least one scheduled event was attended;
allocating points to at least one of the plurality of second financial parties based on a result of the at least one scheduled event; and
calculating and displaying a commission allocation based on, at least in part, the allocated points.

24. The computer-implemented method of claim 22, wherein the meeting type, geography, and a predetermined interest list are maintained in a common database.

25. A computer program product embodied on a physical computer storage medium, the computer program product comprising computer software code that when read from the storage medium and executed, performs the following steps:
searching for at least one scheduled event received as input from a first financial party, the input including at least one of: meeting type, geography of the scheduled event and a predetermined interest list;
sending at least one request for information for the at least one scheduled event over a network to at least one of a plurality of second financial parties; and
calendaring at least one scheduled event based on received information from the at least one of the plurality of second financial parties.

26. The computer program product of claim 25, further comprising computer software code that performs the step of processing a broker vote from a user associated with the first financial party and calculating an amount of points to be allocated to the plurality of second financial parties based on the broker vote.

27. A computer-implemented method for providing targeted communications between a first buy-side entity and at least one second party, the computer-implemented method performed by a computer system having a server and a database, the method comprising the steps of:
searching for internal sponsored events stored in the database based on parameters, wherein the internal sponsored events include at least one of: a conference and a meeting;
cross-referencing the internal sponsored events with an interest list; and
displaying the results of the searching and cross-referencing.

28. The computer-implemented method of claim 27, wherein the cross-referencing step includes cross-referencing based on at least one of: a specific industry, a specific company, a geographic region, a public company and a private company.

29. The computer-implemented method of claim 27, further comprising the steps of:
sending by the server at least one request for information over a network to at least one of second parties; and
calendaring at least one scheduled event based on received information from the at least one of the second parties.

30. The computer-implemented method of claim 29, further comprising receiving a response from the at least one of second parties and displaying a summary of received responses received over a predetermined time period.
